(19) United States
(12) Patent Application Publication
(10) Pub. No.: US 2024/0276488 A1
(43) Pub. Date: Aug. 15, 2024

(54) TECHNIQUES FOR TRANSMITTING A SKIPPING INDICATION FOR CONFIGURED GRANTS

(71) Applicant: QUALCOMM Incorporated, San Diego, CA (US)

(72) Inventors: Linhai HE, San Diego, CA (US); Diana MAAMARI, San Diego, CA (US); Huilin XU, Temecula, CA (US)

(21) Appl. No.: 18/412,122

(22) Filed: Jan. 12, 2024

Related U.S. Application Data
(60) Provisional application No. 63/485,180, filed on Feb. 15, 2023.

(51) Int. Cl. H04W 72/1268; H04W 72/02; H04W 72/0446; H04W 72/21

(52) U.S. Cl. CPC H04W 72/1268; H04W 72/02; H04W 72/0446; H04W 72/21

(57) ABSTRACT

Methods, systems, and devices for wireless communications are described. Some wireless communications systems may support transmission of a skipping indication signaling that a wireless device, such as a user equipment (UE), is to skip uplink transmitting via a resource occasion associated with a configured grant. For example, the UE may receive a first control signal indicating a configured grant (CG) associated with multiple first resource occasions of an uplink shared channel. Additionally, the UE may receive a second control message indicating one or more second resource occasions of an uplink control channel associated with transmitting a skipping indication for the CG. As such, the UE may transmit, via the one or more second resource occasions, the skipping indication for the CG. The skipping indication may signal that the UE is to skip uplink transmitting via at least a portion of the multiple first resource occasions.

### CROSS REFERENCE

The present application for patent claims the benefit of U.S. Provisional Patent Application No. 63/485,180 by H E et al., entitled “TECHNIQUES FOR TRANSMITTING A SKIPPING INDICATION FOR CONFIGURED GRANTS,” filed Feb. 15, 2023, assigned to the assignee hereof, and expressly incorporated by reference herein.

### FIELD OF TECHNOLOGY

The following relates to wireless communications, including techniques for transmitting a skipping indication for configured grants (CGs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for transmitting a skipping indication for configured grants (CGs). Generally, the techniques described herein may support transmission of a skipping indication signaling that a wireless device, such as a user equipment (UE), is to skip uplink transmitting via a resource occasion associated with a configured grant. For example, the UE may receive a first control signal indicating a CG associated with multiple first resource occasions of an uplink shared channel. Additionally, the UE may receive a second control message indicating one or more second resource occasions of an uplink control channel associated with transmitting a skipping indication for the CG. As such, the UE may transmit, via the one or more second resource occasions, the skipping indication for the CG. The skipping indication may signal that the UE is to skip uplink transmitting via at least a portion of the multiple first resource occasions. In some examples, the one or more second resource occasions may occur prior to the multiple first resource occasions in a time domain. Additionally, or alternatively, the one or more second resource occasions may occur after the multiple first resource occasions in the time domain. Additionally, the UE may skip uplink transmitting via the at least portion of the multiple second first resource occasions based on transmitting the skipping indication.

A method for wireless communications at a UE is described. The method may include receiving a first control message indicating a CG associated with a set of multiple first resource occasions of an uplink shared channel, selecting one or more resources of an uplink channel via which the UE is to transmit a skipping indication associated with the CG, and transmitting, via the one or more resources, the skipping indication for the CG, the skipping indication signaling that the UE is to skip uplink transmitting via at least a portion of the set of multiple first resource occasions.

An apparatus for wireless communications at a UE is described. The apparatus may include a processor, memory coupled with the processor, and instructions stored in the memory. The instructions may be executable by the processor to cause the apparatus to receive a first control message indicating a CG associated with a set of multiple first resource occasions of an uplink shared channel, selecting one or more resources of an uplink channel via which the UE is to transmit a skipping indication associated with the CG, and transmit, via the one or more resources, the skipping indication for the CG, the skipping indication signaling that the UE is to skip uplink transmitting via at least a portion of the set of multiple first resource occasions.

Another apparatus for wireless communications at a UE is described. The apparatus may include means for receiving a first control message indicating a CG associated with a set of multiple first resource occasions of an uplink shared channel, means for selecting one or more resources of an uplink channel via which the UE is to transmit a skipping indication for the CG, and means for transmitting, via the one or more resources, the skipping indication for the CG, the skipping indication signaling that the UE is to skip uplink transmitting via at least a portion of the set of multiple first resource occasions.

A non-transitory computer-readable medium storing code for wireless communications at a UE is described. The code may include instructions executable by a processor to receive a first control message indicating a CG associated with a set of multiple first resource occasions of an uplink shared channel, selecting one or more resources of an uplink channel via which the UE is to transmit a skipping indication associated with the CG, and transmit, via the one or more resources, the skipping indication for the CG, the skipping indication signaling that the UE is to skip uplink transmitting via at least a portion of the set of multiple first resource occasions.

In some examples of the method, apparatuses, and non-transitory computer-readable medium described herein, the skipping indication occurs prior to the set of multiple first resource occasions in a time domain.

In some examples of the method, apparatuses, and non-transitory computer-readable medium described herein, transmitting the skipping indication for the CG may include operations, features, means, or instructions for transmitting, via the skipping indication, an indication of the at least portion of the set of multiple first resource occasions for which the UE may be to skip uplink transmitting.

Some examples of the method, apparatuses, and non-transitory computer-readable medium described herein may further include operations, features, means, or instructions for receiving a third control message indicating a set of durations associated with the set of multiple first resource occasions, where transmitting the skipping indication for the CG includes transmitting, via the skipping indication, an indication of one or more durations from the set of durations, and where the one or more durations may be associated with the at least portion of the set of multiple first resource occasions.

In some examples of the method, apparatuses, and non-transitory computer-readable medium described herein, each duration from the set of durations may be associated with an index and the indication of the one or more durations includes an indication of the indices associated with the one or more durations.

In some examples of the method, apparatuses, and non-transitory computer-readable medium described herein, transmitting the skipping indication for the CG may include operations, features, means, or instructions for transmitting, via the skipping indication, an indication of a first resource occasion of the set of multiple first resource occasions, where the skipping indication signals that the UE may be to skip uplink transmitting for the set of multiple first resource occasions based on indicating the first resource occasion of the set of multiple first resource occasions.

In some examples of the method, apparatuses, and non-transitory computer-readable medium described herein, the set of multiple first resource occasions may be further associated with a set of multiple CGs including at least the CG and the skipping indication may be applicable to the at least portion of the set of multiple first resource occasions across the set of multiple CGs.

In some examples of the method, apparatuses, and non-transitory computer-readable medium described herein, the set of multiple first resource occasions may be associated with a set of multiple cells and the method, apparatuses, and non-transitory computer-readable medium may include further operations, features, means, or instructions for transmitting the skipping indication to the first cell of the set of multiple cells.

Some examples of the method, apparatuses, and non-transitory computer-readable medium described herein may further include operations, features, means, or instructions for skipping uplink transmitting via the at least portion of the set of multiple first resource occasions based on transmitting the skipping indication.

Some examples of the method, apparatuses, and non-transitory computer-readable medium described herein may further include operations, features, means, or instructions for receiving a fourth control message indicating one or more logical channels over which the UE may refrain from skipping uplink transmitting.

Some examples of the method, apparatuses, and non-transitory computer-readable medium described herein may further include operations, features, means, or instructions for receiving a third control message scheduling data associated with the one or more logical channels over which the UE may refrain from skipping uplink transmitting and transmitting the data associated with the one or more logical channels via the at least portion of the set of multiple first resource occasions based on the data being scheduled over the one or more logical channels after transmission of the skipping indication.

In some examples of the method, apparatuses, and non-transitory computer-readable medium described herein, each of the one or more logical channels may be associated with a signal radio bearer (SRB) or a delay sensitive quality of service (QoS) flow.

In some examples of the method, apparatuses, and non-transitory computer-readable medium described herein, the one or more resources occur after the set of multiple first resource occasions in a time domain.

Some examples of the method, apparatuses, and non-transitory computer-readable medium described herein may further include operations, features, means, or instructions for receiving a third control message requesting retransmission of data via the at least portion of the set of multiple first resource occasions, where transmitting the skipping indication after the set of multiple first resource occasions may be based on receiving the third control message.

In some examples of the method, apparatuses, and non-transitory computer-readable medium described herein, the third control message indicates a radio network temporary identifier (RNTI) associated with the UE and feedback process identifiers associated each first resource occasion of the at least portion of the set of multiple first resource occasions.

In some examples of the method, apparatuses, and non-transitory computer-readable medium described herein, a second control message indicates a set of multiple resource occasions of the uplink channel, including at least the one or more resources.

In some examples of the method, apparatuses, and non-transitory computer-readable medium described herein, one or more third resource occasions associated with the uplink control channel at least partially overlap with one or more first resource occasions of the at least portion of the set of multiple first resource occasions, and the method, apparatuses, and non-transitory computer-readable medium may include further operations, features, means, or instructions for transmitting uplink control information (UCI) via the one or more third resource occasions.

In some examples of the method, apparatuses, and non-transitory computer-readable medium described herein, one or more third resource occasions associated with the uplink control channel at least partially overlap with one or more first resource occasions of the at least portion of the set of multiple first resource occasions, and the method, apparatuses, and non-transitory computer-readable medium may include further operations, features, means, or instructions for multiplexing UCI with a transport block (TB) and transmitting the multiplexed UCI via the one or more first resource occasions of the at least portion of the set of multiple first resource occasions.

In some examples of the method, apparatuses, and non-transitory computer-readable medium described herein, one or more third resource occasions associated with the uplink control channel at least partially overlap with one or more first resource occasions of the at least portion of the set of multiple first resource occasions, and the method, apparatuses, and non-transitory computer-readable medium may include further operations, features, means, or instructions for receiving a third control message indicating whether the UE may transmit UCI via the one or more third resource occasions or may transmit the UCI via the one or more first resource occasions.

In some examples of the method, apparatuses, and non-transitory computer-readable medium described herein, a first subset of the at least portion of the set of multiple first resource occasions may be associated with a first frequency and a second subset of the at least portion of the set of multiple first resource occasions may be associated with a second frequency.

A method for wireless communications at a network entity is described. The method may include transmitting a first control message indicating a CG associated with a set of multiple first resource occasions of an uplink shared channel, and receiving, via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions.

An apparatus for wireless communications at a network entity is described. The apparatus may include a processor, memory coupled with the processor, and instructions stored in the memory. The instructions may be executable by the processor to cause the apparatus to transmit a first control message indicating a CG associated with a set of multiple first resource occasions of an uplink shared channel, and receive, via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions.

Another apparatus for wireless communications at a network entity is described. The apparatus may include means for transmitting a first control message indicating a CG associated with a set of multiple first resource occasions of an uplink shared channel, and means for receiving, via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions.

A non-transitory computer-readable medium storing code for wireless communications at a network entity is described. The code may include instructions executable by a processor to transmit a first control message indicating a CG associated with a set of multiple first resource occasions of an uplink shared channel, and receive, via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions.

In some examples of the method, apparatuses, and non-transitory computer-readable medium described herein, the skipping indication occurs prior to the set of multiple first resource occasions in a time domain.

In some examples of the method, apparatuses, and non-transitory computer-readable medium described herein, transmitting the skipping indication for the CG may include operations, features, means, or instructions for receiving, via the skipping indication, an indication of the at least portion of the set of multiple first resource occasions for which the UE may be to skip uplink transmitting.

Some examples of the method, apparatuses, and non-transitory computer-readable medium described herein may further include operations, features, means, or instructions for transmitting a third control message indicating a set of durations associated with the set of multiple first resource occasions, where transmitting the skipping indication for the CG includes transmitting, via the skipping indication, an indication of one or more durations from the set of durations, and where the one or more durations may be associated with the at least portion of the set of multiple first resource occasions.

In some examples of the method, apparatuses, and non-transitory computer-readable medium described herein, each duration from the set of durations may be associated with an index and the indication of the one or more durations includes an indication of the indices associated with the one or more durations.

In some examples of the method, apparatuses, and non-transitory computer-readable medium described herein, transmitting the skipping indication for the CG may include operations, features, means, or instructions for receiving, via the skipping indication, an indication of a first resource occasion of the set of multiple first resource occasions, where the skipping indication signals that the UE may be to skip uplink transmitting for the set of multiple first resource occasions based on indicating the first resource occasion of the set of multiple first resource occasions.

In some examples of the method, apparatuses, and non-transitory computer-readable medium described herein, the set of multiple first resource occasions may be associated with a set of multiple cells and the skipping indication may be applicable to the at least portion of the set of multiple first resource occasions across the set of multiple cells.

Some examples of the method, apparatuses, and non-transitory computer-readable medium described herein may further include operations, features, means, or instructions for transmitting a third control message indicating a first cell of the set of multiple cells for transmission of the skipping indication, where the skipping indication may be transmitted to the first cell in accordance with the third control message.

In some examples of the method, apparatuses, and non-transitory computer-readable medium described herein, the set of multiple first resource occasions may be associated with a set of multiple cells, the skipping indication may be applicable to a first cell of the set of multiple cells, and the network entity may be the first cell.

Some examples of the method, apparatuses, and non-transitory computer-readable medium described herein may further include operations, features, means, or instructions for refraining from monitoring for uplink transmissions via the at least portion of the set of multiple first resource occasions based on receiving the skipping indication.

Some examples of the method, apparatuses, and non-transitory computer-readable medium described herein may further include operations, features, means, or instructions for transmitting a fourth control message indicating one or more logical channels over which the UE may refrain from skipping uplink transmitting.

Some examples of the method, apparatuses, and non-transitory computer-readable medium described herein may further include operations, features, means, or instructions for transmitting a third control message scheduling data over the one or more logical channels associated with the uplink control channel and receiving the data over the one or more logical channels via the at least portion of the set of multiple first resource occasions based on the data being scheduled over the one or more logical channels after transmission of the skipping indication.

In some examples of the method, apparatuses, and non-transitory computer-readable medium described herein, each of the one or more logical channels may be associated with a SRB or a delay sensitive QoS flow.

In some examples of the method, apparatuses, and non-transitory computer-readable medium described herein, the one or more resources occur after the set of multiple first resource occasions in a time domain.

Some examples of the method, apparatuses, and non-transitory computer-readable medium described herein may further include operations, features, means, or instructions for transmitting a third control message requesting retransmission of data via the at least portion of the set of multiple first resource occasions, where receiving the skipping indication after the set of multiple first resource occasions may be based on receiving the third control message.

In some examples of the method, apparatuses, and non-transitory computer-readable medium described herein, the third control message indicates an RNTI associated with the UE and indicates feedback process identifiers associated each first resource occasion of the at least portion of the set of multiple first resource occasions.

In some examples of the method, apparatuses, and non-transitory computer-readable medium described herein, a second control message indicates a set of multiple resource occasions of the uplink channel, including at least the one or more resources.

In some examples of the method, apparatuses, and non-transitory computer-readable medium described herein, one or more third resource occasions associated with the uplink control channel at least partially overlap with one or more first resource occasions of the at least portion of the set of multiple first resource occasions, and the method, apparatuses, and non-transitory computer-readable medium may include further operations, features, means, or instructions for receiving UCI via the one or more third resource occasions.

In some examples of the method, apparatuses, and non-transitory computer-readable medium described herein, one or more third resource occasions associated with the uplink control channel at least partially overlap with one or more first resource occasions of the at least portion of the set of multiple first resource occasions, and the method, apparatuses, and non-transitory computer-readable medium may include further operations, features, means, or instructions for receiving UCI multiplexed with a TB via the one or more first resource occasions of the at least portion of the set of multiple first resource occasions.

In some examples of the method, apparatuses, and non-transitory computer-readable medium described herein, one or more third resource occasions associated with the uplink control channel at least partially overlap with one or more first resource occasions of the at least portion of the set of multiple first resource occasions, and the method, apparatuses, and non-transitory computer-readable medium may include further operations, features, means, or instructions for transmitting a third control message indicating whether the UE may transmit UCI via the one or more third resource occasions or may transmit the UCI via the one or more first resource occasions.

In some examples of the method, apparatuses, and non-transitory computer-readable medium described herein, a first subset of the at least portion of the set of multiple first resource occasions may be associated with a first frequency and a second subset of the at least portion of the set of multiple first resource occasions may be associated with a second frequency.

### BRIEF DESCRIPTION OF THE DRAWINGS

FIG. 1 illustrates an example of a wireless communications system that supports techniques for transmitting a skipping indication for configured grants (CGs) in accordance with one or more aspects of the present disclosure.

FIG. 2 illustrates an example of a wireless communications system that supports techniques for transmitting a skipping indication for CGs in accordance with one or more aspects of the present disclosure.

FIG. 3 illustrates examples of timing diagrams that supports techniques for transmitting a skipping indication for CGs in accordance with one or more aspects of the present disclosure.

FIG. 4 illustrates an example of a process flow that supports techniques for transmitting a skipping indication for CGs in accordance with one or more aspects of the present disclosure.

FIGS. 5 and 6 illustrate block diagrams of devices that support techniques for transmitting a skipping indication for CGs in accordance with one or more aspects of the present disclosure.

FIG. 7 illustrates a block diagram of a communications manager that supports techniques for transmitting a skipping indication for CGs in accordance with one or more aspects of the present disclosure.

FIG. 8 illustrates a diagram of a system including a device that supports techniques for transmitting a skipping indication for CGs in accordance with one or more aspects of the present disclosure.

FIGS. 9 and 10 illustrate block diagrams of devices that support techniques for transmitting a skipping indication for CGs in accordance with one or more aspects of the present disclosure.

FIG. 11 illustrates a block diagram of a communications manager that supports techniques for transmitting a skipping indication for CGs in accordance with one or more aspects of the present disclosure.

FIG. 12 illustrates a diagram of a system including a device that supports techniques for transmitting a skipping indication for CGs in accordance with one or more aspects of the present disclosure.

FIGS. 13 and 14 illustrate flowcharts showing methods that support techniques for transmitting a skipping indication for CGs in accordance with one or more aspects of the present disclosure.

### DETAILED DESCRIPTION

Some wireless communications systems may support configuration of resource occasions of an uplink shared channel via configured grant (CG). That is, a user equipment (UE) may receive a control message indicating a CG associated with multiple resource occasions of the uplink shared channel, such as a physical uplink shared channel (PUSCH). The multiple resource occasions of the uplink shared channel may be referred to as PUSCH resource occasions. As such, the UE may transmit uplink messages to a network entity via the multiple PUSCH occasions associated with the CG. In some cases the UE may not have data to transmit to the network entity via one or more PUSCH resource occasions of the multiple PUSCH resource occasions. In such cases, the UE may skip the one or more PUSCH resource occasions, however, the network entity may still monitor for a transmission via the one or more skipped PUSCH resource occasions, which may result inefficient resource utilization.

Accordingly, various aspects described herein relate generally to wireless communications and more particularly to transmission of a skipping indication signaling that a UE is to skip uplink transmitting via one or more PUSCH resource occasions associated with a CG. For example, the UE may receive, from a network entity, a first control message indicating a CG associated with multiple PUSCH resource occasions. Additionally, the UE may receive a second control message indicating one or more resource occasions associated with an uplink control channel, which may be referred to as PUCCH resource occasions, over which the UE may transmit a skipping indication. In some examples (e.g., pre-occasion), the one or more PUCCH resource occasions may be prior to the multiple PUSCH resource occasions in a time domain. Additionally, or alternatively, the one or more PUCCH resource occasions may be after the multiple PUSCH resource occasions in the time domain. As such, the UE may transmit, via at least a subset of the one or more PUCCH resource occasions, a skipping indication signaling that the UE is to skip uplink transmitting via at least a portion of the multiple PUSCH resource occasions. As such, the UE may skip uplink transmitting via the at least portion of the multiple PUSCH resource occasions based on transmitting the skipping indication.

Particular aspects of the subject matter described in this disclosure can be implemented to realize one or more of the following potential advantages. In some examples, by transmitting a skipping indication, the described techniques may be used to enable a network entity to re-allocate resources associated with resource occasions to be skipped by a UE, which may result in improved resource utilization. Additionally, by transmitting a skipping indication, a UE may skip uplink transmitting via one or more resource occasions, which may result in reduced power consumption.

Aspects of the disclosure are initially described in the context of wireless communications systems. Aspects of the disclosure are then described in the context of a timing diagram and a process flow. Aspects of the disclosure are further illustrated by and described with reference to apparatus diagrams, system diagrams, and flowcharts that relate to techniques for transmitting a skipping indication for configured grants.

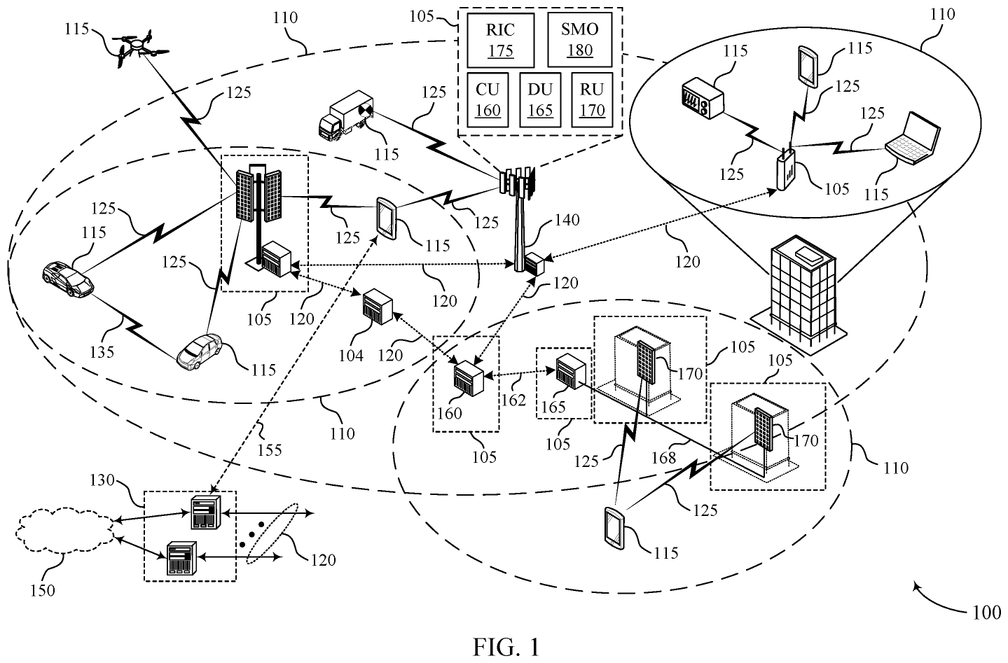

FIG. 1 illustrates an example of a wireless communications system 100 that supports techniques for transmitting a skipping indication for CGs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for transmitting a skipping indication for configured grants as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support transmission of a skipping indication signaling that a UE 115 is to skip (e.g., cancel or postpone) uplink transmitting via one or more PUSCH resource occasions associated with a CG. For example, the UE 115 may receive, from a network entity 105, a first control message indicating a CG associated with multiple PUSCH resource occasions. Additionally, the UE 115 may receive a second control message indicating one or more resource occasions associated with an uplink control channel, which may be referred to as PUCCH resource occasions, over which the UE 115 may transmit a skipping indication. In some examples (e.g., pre-occasion), the one or more PUCCH resource occasions may be prior to the multiple PUSCH resource occasions in a time domain. Additionally, or alternatively, the one or more PUCCH resource occasions may be after the multiple PUSCH resource occasions in the time domain. As such, the UE 115 may transmit, via at least a subset of the one or more PUCCH resource occasions, a skipping indication signaling that the UE 115 is to skip uplink transmitting via at least a portion of the multiple PUSCH resource occasions.

In some examples, the UE 115 may skip uplink transmitting via the at least portion of the multiple PUSCH resource occasions based on transmitting the skipping indication (e.g., regardless of whether data is scheduled after transmission of the skipping indication). Alternatively, the UE 115 may receive a third control message indicating one or more logical channels, such that the UE 115 may transmit data scheduled after transmission of the skipping indication via the at least portion of the multiple PUSCH resource occasions based on the data being associated with the one or more logical channels.

In cases, a PUCCH resource occasion may overlap with a PUSCH resource occasions of the at least portion of the multiple PUSCH resource occasions. Additionally, the UE 115 may schedule transmission of uplink control information (UCI) via the overlapping PUCCH resource occasion. In some examples, the UE 115 may multiplex the UCI with a TB (e.g., dummy TB) and transmit the multiplexed UCI via the overlapping PUSCH resource occasion. Alternatively, the UE 115 may transmit the UCI via the overlapping PUCCH resource occasions and skip (e.g., refrain from uplink transmitting via) the overlapping PUSCH resource occasions of the at least portion of the multiple resource occasions indicated via the skipping indication.

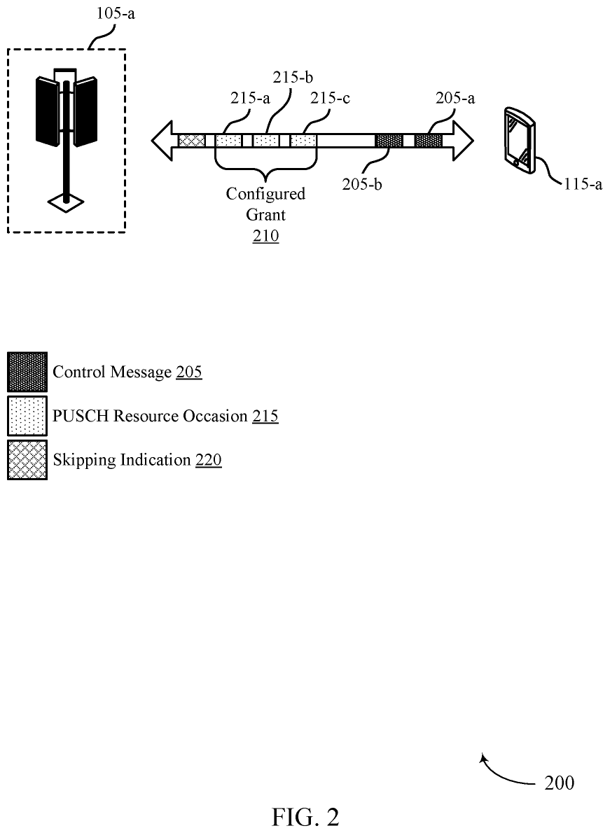

FIG. 2 illustrates an example of a wireless communications system 200 that supports techniques for transmitting a skipping indication for CGs in accordance with one or more aspects of the present disclosure. The wireless communications system 200 may implement or be implemented by aspects of the wireless communication system 100. For example, the wireless communications system 200 may include one or more network entities 105 (e.g., a network entity 105-a) and one or more UEs 115 (e.g., a UE 115-a), which may represent examples of corresponding devices as described with reference to FIG. 1. In some examples, the UE 115-a may transmit a skipping indication 220 signaling that the UE 115-a is to skip uplink transmitting via one or more PUSCH resource occasions 215 of multiple PUSCH resource occasions 215 associated with a CG 210.

Some wireless communications systems, such as the wireless communications system 200, may support indicating (e.g., configuration) multiple resource occasions of an uplink shared channel (e.g., PUSCH) to a UE 115, such as the UE 115-a, via a CG 210. The resource occasions of the uplink shared channel may be referred to as PUSCH resource occasions 215 (e.g., CG PUSCH resource occasions 215). That is, a UE 115, such as the UE 115-a, may receive, from a network entity 105-a, a control message 205 indicating the CG 210 associated with the multiple PUSCH resource occasions 215. As such, the UE 115-a may transmit uplink messages (e.g., uplink data) via the multiple PUSCH resource occasions 215.

However, in some examples, the UE 115-a may not schedule transmission of uplink messages via one or more PUSCH resource occasions 215 of the multiple PUSCH resource occasions 215 associated with the CG 210. In other words, the UE 115-a may not have data to transmit to the network entity 105-a via the one or more PUSCH resource occasions 215. In such cases, the UE 115-a may skip uplink transmitting (e.g., skip transmission of uplink signaling) via the one or more PUSCH resource occasions 215 (e.g., without network entity 105-a configuration). In other words, the UE 115-a may skip the one or more PUSCH resource occasions 215 without indicating the skipping to the network entity 105-a (e.g., no indication to the network entity 105-a is needed if the UE 115-a determines, or chooses, to skip the one or more PUSCH resource occasions 215). However, the network entity 105-a may monitor for transmissions via the one or more skipped PUSCH resource occasions 215, resulting in increased power consumption and inefficient resource utilization (e.g., the network entity 105-a may not re-allocate resources associated with the one or more skipped PUSCH resource occasions 215).

Additionally, or alternatively, a resource occasion associated with an uplink control channel (e.g., PUCCH), which may be referred to as a PUCCH resource occasion, may overlap with the a PUSCH resource occasions 215 of the one or more PUSCH resource occasions 215 to be skipped by the UE 115-a. Additionally, the UE 115-a may schedule transmission of UCI via the overlapping PUCCH resource occasion. However (e.g., even if the UE 115-a has no data to transmit over the overlapping PUSCH resource occasion 215), the UE 115-a may multiplex the UCI on a TB (e.g., dummy TB, empty TB) and transmit the multiplexed UCI via the overlapping PUSCH resource occasion 215. In some examples, multiple PUSCH resource occasions 215 of the one or more PUSCH resource occasions 215 to be skipped by the UE 115 may be on different component carriers (CCs) and may overlap with a PUCCH resource occasion (e.g., associated with UCI to be transmitted by the UE 115-a). In such cases, the UE 115-a may determine which overlapping PUSCH resource occasion 215 of the multiple overlapping PUSCH resource occasions 215 to multiplex the UCI based on an indicated order (e.g., pre-defined order). In either cases, transmission of multiplexed UCI via PUSCH resource occasions 215 that were to be skipped by the UE 115-a may result inefficient resource utilization.

Accordingly, techniques described herein may support transmission of a skipping indication 220 signaling that a UE 115, such as the UE 115-a, is to skip uplink transmitting via one or more PUSCH resource occasions 215 of multiple PUSCH resource occasions 215 associated with a CG 210 to improve system capacity (e.g.,., a network entity 105, such as a network entity 105-a, may re-allocate resources associated with the one or more skipped PUSCH resource occasions 215). For example, the UE 115-a may receive a control message 205-a indicating a CG 210 associated with multiple PUSCH resource occasions 215, including a PUSCH resource occasion 215-a, a PUSCH resource occasion 215-b, and a PUSCH resource occasion 215-c. Additionally, the UE 115-a may receive a control message 205-b indicating a set of (e.g., one or more) PUCCH resource occasions over which the UE 115-a may transmit a skipping indication 220 (e.g., uplink skipping indication 220) for the CG 210. In some examples, the set of PUCCH resource occasions may include a single PUCCH resource occasion over which the UE 115-a may transmit the skipping indication 220. Alternatively, the set of PUCCH resource occasions may include multiple PUCCH resource occasions, such that the UE 115-a may select one or more PUCCH resource occasions from the multiple PUCCH resource occasion over which to transmit the skipping indication 220.

In some examples (e.g. pre-occasion indication), the set of PUCCH resources may be prior to the multiple PUSCH resource occasions 215 in a time domain. As such, the UE 115-a may transmit the skipping indication 220 indicating that the UE 115-a may skip uplink transmitting via one or more PUSCH resource occasions 215 of the multiple PUSCH resource occasions 215. In some examples, the skipping indication 220 may indicate a quantity of (e.g., how many) PUSCH resource occasions 215 from the multiple PUSCH resource occasions 215 (E.g., in the CG 210) that the UE 115-a is to skip uplink transmitting. The quantity of PUSCH resource occasions 215 may be a subsequent PUSCH resource occasions 215, consecutive resource occasions 215, or both.

Additionally, or alternatively, the UE 115-a may receive an additional control message 205 indicating a set of durations (e.g., for skipping) associated with the CG 210, where each duration of the set of durations is associated with an index. As such, the skipping indication 220 may indicate one or more indices associated with one or more durations of the set of durations over which the UE 115-a may skip uplink transmitting. The one or more durations of the set of durations indicated via the skipping indication 220 may include the one or more PUSCH resource occasions 215 over which the UE 115-a may skip uplink transmitting.

Additionally, or alternatively, the skipping indication 220 may indicate that the UE 115-a is to skip uplink transmitting via the one or more PUSCH resource occasions 215 of the multiple PUSCH resource occasions 215 in a slot corresponding to the skipping indication 220 for all CGs 210 of a set of CGs 210 associated with the UE 115-a, for all serving cells of a set of serving cells associated with the UE 115-a, or both. In such cases, the UE 115-a may receive an additional control message 205 indicating a serving cell from the set of serving cells and the UE 115-a may transmit the skipping indication 220 to the indicated serving cell.

Alternatively (e.g., post-occasion indication), the set of PUCCH resources may be after the multiple PUSCH resource occasions 215 in the time domain. In such cases, the UE 115-a may skip uplink transmitting via the one or more PUSCH resource occasions 215 of the multiple PUSCH resource occasions 215 and may receive a request to retransmit (e.g., control message 205 requesting retransmission) data associated with the one or more skipped PUSCH resource occasions 215 (e.g., based on the network entity 105-a expecting data to be transmitted via the one or more skipped PUSCH resource occasions 215). As such, the UE 115-a may transmit the skipping indication 220 after the multiple PUSCH resource occasions 215 (e.g., rather than transmitting a retransmission).

In some examples, the UE 115-a may refrain from transmitting (e.g., may not need to transmit) a skipping indication 220 outside of an active time of a discontinuous reception (DRX) associated with the UE 115-a.

In some cases, the UE 115-a may not transmit a skipping indication 220 prior to a PUSCH resource occasion 215 associated with the CG 210, such as the PUSCH resource occasion 215-b, however, the UE 115-a may not have uplink data to transmit via the PUSCH resource occasion 215-b (e.g., may not have any buffered uplink data in a slot of the PUSCH resource occasion 215-b). In some examples, the UE 115-a may transmit a TB (e.g., dummy TB, padding bits) via the PUSCH resource occasion 215-b. In another example, the UE 115-a may skip the PUSCH resource occasion 215-b. In such cases, the UE 115-a may receive a control message 205 indicating whether the UE 115-a may transmit a TB via a PUSCH resource occasion 215 if the PUSCH resource occasion 215 is not associated with data or may skip the PUSCH resource occasion 215 based on the PUSCH resource occasion 215 not being associated with data.

In some cases, the PUSCH resource occasions 215 may be associated with multiple serving cells (e.g., network entities 105, including at least the network entity 105-a) or may be associated with a single serving cell, such as the network entity 105-a, but may be associated with different frequency resources. That is, the PUSCH resource occasion 215-a, the PUSCH resource occasion 215-b, and the PUSCH occasion 215-c may be associated with the network entity 105-a. Additionally, the PUSCH resource occasion 215-a may be associated with a first frequency, the PUSCH resource occasion 215-b may be associated with a second frequency, and the PUSCH occasion 215-c may be associate with a third frequency. As such, the UE 115-a may determine which PUSCH resource occasions 215 to skip (e.g., if the skipping indication 220 is associated with (e.g., indicates) a single PUSCH resource occasion 215 and the UE 115 does not have enough data to use all the PUSCH resource occasions 215).

Similarly, PUSCH resource occasions 215 may be associated with multiple CGs 210. In such cases, the UE 115-a may determine which PUSCH resource occasions 215 in which CGs 210 of the multiple CGs 210 to skip. For example, the UE 115-a may skip all PUSCH resource occasions 215 associated with a first CG 210 of the multiple CGs 210. Additionally, or alternatively, the UE 115-a may skip a last PUSCH resource occasion 215 of each CG 210 of the multiple CGs 210. Additionally, or alternatively, the UE 115-a may skip a first PUSCH resource occasion 215 associated with a first CG 210 of the multiple CGs 210 and may skip a last PUSCH resource occasion 215 of a second CG 210 from the multiple CGs 210.

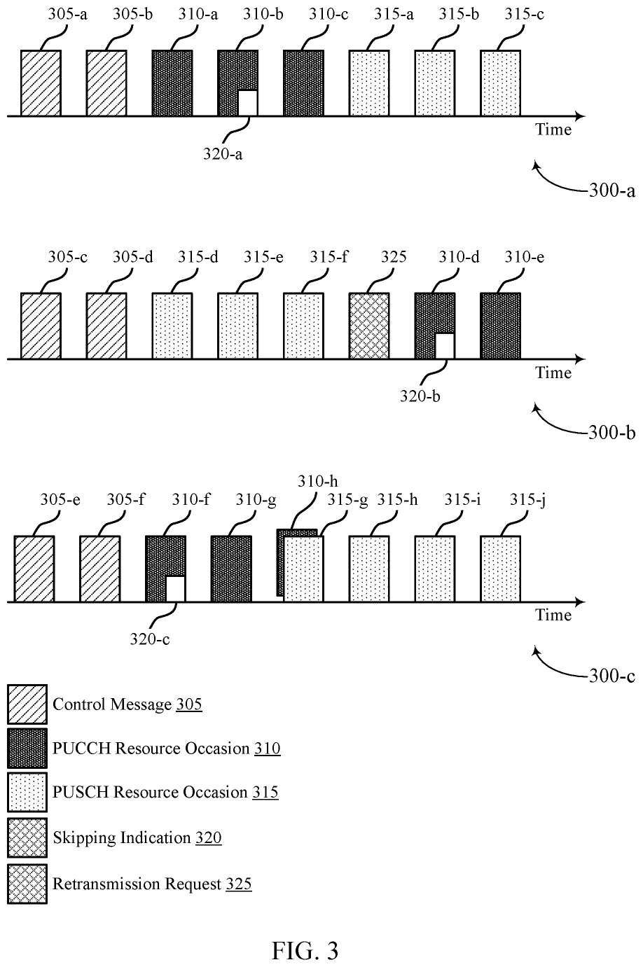

FIG. 3 illustrates examples of timing diagrams 300 that supports techniques for transmitting a skipping indication for CGs in accordance with one or more aspects of the present disclosure. The timing diagrams 300 (e.g., a timing diagram 300-a, a timing diagram 300-b, and a timing diagram 300-c) may implement or be implemented by aspects of the wireless communication system 100 and the wireless communications system 200. For example, the timing diagrams 300 may be implemented by one or more network entities 105 and one or more UEs 115, which may represent examples of corresponding devices as described with reference to FIG. 1. In some examples, a UE 115 may transmit a skipping indication 320 signaling that the UE 115 is to skip uplink transmitting via one or more PUSCH resource occasions 315 of multiple PUSCH resource occasions 315 associated with a CG.

In some examples, as described with reference to the timing diagram 300-a, a UE 115 may receive a control message 305-a indicating a CG associated with multiple PUSCH resource occasions 315, including a PUSCH resource occasion 315-a, a PUSCH resource occasion 315-b, and a PUSCH resource occasion 315-c. Additionally, the UE 115 may receive a control message 305-b indicating a set of PUCCH resource occasions 310 over which the UE 115 may transmit a skipping indication 320 for the CG, including a PUCCH resource occasion 310-a, a PUCCH resource occasion 310-b, and a PUCCH resource occasion 310-c.

In some examples, the UE 115 may identify one or more PUSCH resource occasions 315 from the PUSCH resource occasion 315-a, the PUSCH resource occasion 315-b, and the PUSCH resource occasion 315-c over which the UE 115 may skip uplink transmitting. For example, the UE 115 may identify the PUSCH resource occasion 315-b to skip (e.g., skip uplink transmitting via resource associated with the PUSCH resource occasion 315-b). Additionally, the UE 115 may select a PUCCH resource occasion 310 from the PUCCH resource occasion 310-a, the PUCCH resource occasion 310-b, and the PUCCH resource occasion 310-c over which to transmit a skipping indication 320-a signaling that the UE 115 is to skip the PUSCH resource occasion 315-b. For example, the UE 115 may select the PUCCH resource occasion 310-b and transmit the skipping indication 320-a via the PUCCH resource occasion 310-b (e.g., via resource associated with the PUCCH resource occasion 310-b).

In some examples, the UE 115 may receive an additional control message 305 scheduling data after transmission of the skipping indication 320-a. In other words, the UE 115 may have data available for transmission via the PUSCH resource occasion 315-b. In some examples, the UE 115 may refrain from transmitting the data via the PUSCH resource occasion 315-b based on the UE 115 transmitting the skipping indication 320-a. Alternatively, the UE 115 may transmit the data via the PUSCH resource occasion 315-b based on the data being associated with an indicated logical channel. That is, the UE 115 may receive another control message 305 indicating one or more logical channels over which the UE 115 may refrain from skipping uplink transmitting (e.g., may transmit signaling even if the UE 115 has transmitted an associated skipping indication 320). In some cases, the one or more logical channels may be associated with a signal radio bearer (SRB) or a delay sensitive quality of service (QoS) flow. As such, the UE 115-a may transmit the data via the PUSCH resource occasion 315-b based on the data being associated with the one or more logical channels.

In some examples, as described with reference to the timing diagram 300-b, a UE 115 may receive a control message 305-c indicating a CG associated with multiple PUSCH resource occasions 315, including a PUSCH resource occasion 315-d, a PUSCH resource occasion 315-e, and a PUSCH resource occasion 315-f. Additionally, the UE 115 may receive a control message 305-d indicating a set of PUCCH resource occasions 310 over which the UE 115 may transmit a skipping indication 320 for the CG, including a PUCCH resource occasion 310-d and a PUCCH resource occasion 310-e.

In some examples, the UE 115 may skip one or more PUSCH resource occasions 315 from the PUSCH resource occasion 315-d, the PUSCH resource occasion 315-e, and the PUSCH resource occasion 315-f. For example, the UE 115 may skip the PUSCH resource occasion 315-f (e.g., skip uplink transmitting via resource associated with the PUSCH resource occasion 315-f). Additionally, the UE 115 may receive a retransmission request 325. That is, a network entity 105 may monitor for data via the PUSCH resource occasion 315-f and may not receive data (e.g., based on the UE 115 skipping the PUSCH resource occasion 315-f). As such, the network entity may transmit a retransmission request 325 (e.g., a retransmission DCI) indicating an identifier (e.g. configured scheduling radio network temporary identifier (CS-RNTI) associated with the UE 115, a feedback (e.g., HARQ) process identifier associated with the PUSCH resource occasion 315-f, or both. In such cases, the UE 115 may select a PUCCH resource occasion 310 from the PUCCH resource occasion 310-d and the PUCCH resource occasion 310-e over which to transmit a skipping indication 320-b signaling that the UE 115 skipped the PUSCH resource occasion 315-f. For example, the UE 115 may select the PUCCH resource occasion 310-d and transmit the skipping indication 320-b via the PUCCH resource occasion 310-d (e.g., via resource associated with the PUCCH resource occasion 310-d).

In some examples, as described with reference to the timing diagram 300-c, a UE 115 may receive a control message 305-e indicating a CG associated with multiple PUSCH resource occasions 315, including a PUSCH resource occasion 315-g, a PUSCH resource occasion 315-h, a PUSCH resource occasion 315-i, and a PUSCH resource occasion 315-j. Additionally, the UE 115 may receive a control message 305-f indicating a set of PUCCH resource occasions 310 over which the UE 115 may transmit a skipping indication 320-c for the CG, including a PUCCH resource occasion 310-f, a PUCCH resource occasion 310-g, and a PUCCH resource occasion 310-h.

Additionally, the UE 115 may identify one or more PUSCH resource occasions 315 from the PUSCH resource occasion 315-g, the PUSCH resource occasion 315-h, the PUSCH resource occasion 315-i, and the PUSCH resource occasion 315-j over which the UE 115 may skip uplink transmitting. For example, the UE 115 may identify the PUSCH resource occasion 315-g to skip (e.g., based on the UE 115 not having any uplink data eligible for transmission via the PUSCH resource occasion 315-g). Additionally, the UE 115 may select a PUCCH resource occasion 310 from the PUCCH resource occasion 310-f, the PUCCH resource occasion 310-g, and the PUCCH resource occasion 310-h over which to transmit a skipping indication 320-c signaling that the UE 115 is to skip the PUSCH resource occasion 315-g. For example, the UE 115 may select the PUCCH resource occasion 310-f and transmit the skipping indication 320-c via the PUCCH resource occasion 310-f (e.g., via resource associated with the PUCCH resource occasion 310-f).

However, in some cases, the UE 115 may schedule (e.g., have) UCI via a PUCCH resource occasion 310 that overlaps with a PUSCH resource occasion 315 indicated via a skipping indication 320 (e.g., or to be indicated via the skipping indication 320). For example, the UE 115 may schedule UCI via the PUCCH resource occasion 310-h that overlaps (e.g., at least partially) with the PUSCH resource occasion 315-g in a time domain. In some cases, the UE 115 may transmit the UCI via the PUCCH resource occasion 310-h and may skip uplink transmitting via the PUSCH resource occasion 315-g (e.g., may not transmit uplink signaling via the PUSCH resource occasion 315-g). Alternatively, the UE 115 may multiple the UCI with a TB (e.g., dummy TB) and transmit the multiplexed UCI via the PUSCH resource occasion 315-g. The network entity 105 may transmit a control message 305 indicating whether the UE 115 may transmit UCI via PUCCH resource occasions 310 that overlap with PUSCH resource occasions 315 to be skipped by the UE 115 or may multiplex the UCI with a TB to be transmitted via the PUSCH resource occasions 315 that overlaps with the PUSCH resource occasions 315.

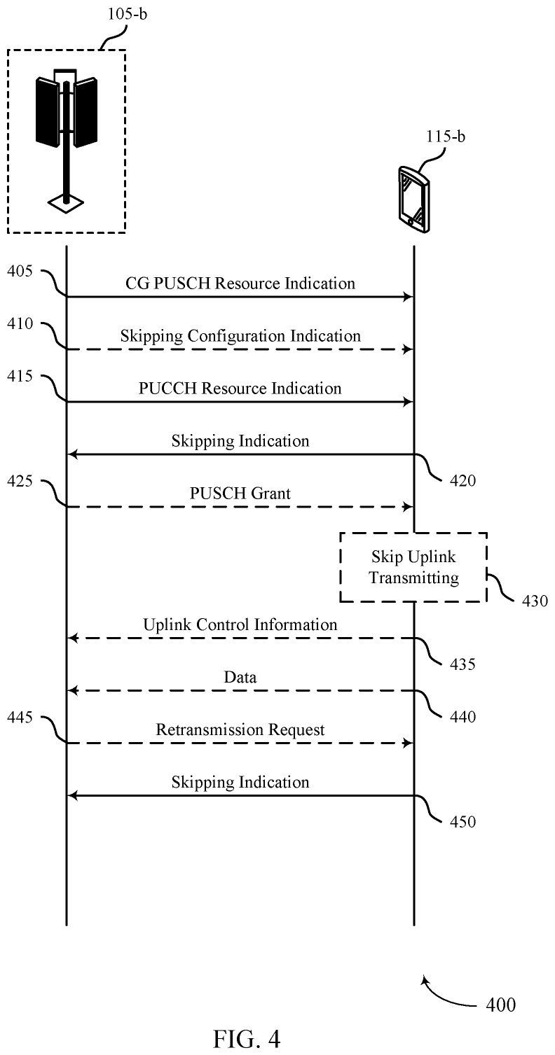

FIG. 4 illustrates an example of a process flow 400 that supports techniques for transmitting a skipping indication for CGs in accordance with one or more aspects of the present disclosure. The process flow 400 may implement or be implemented by aspects of the wireless communication system 100, the wireless communications system 200, and the timing diagrams 300. For example, the process flow 400 may be implemented by one or more network entities 105 (e.g., a network entity 105-b) and one or more UEs 115 (e.g., a UE 115-b), which may represent examples of corresponding devices as described with reference to FIG. 1. In some examples, the UE 115-b may transmit a skipping indication signaling that the UE 115-b is to skip uplink transmitting via one or more resource occasions of multiple resource occasions associated with a CG.

At 405, the UE 115-b may receive, from the network entity 105-b, a first control message, which may be referred to as a CG PUSCH resource indication, indicating a CG associated with multiple first resource occasions of an uplink shared channel (e.g., PUSCH resource occasions). In some examples, the multiple first resource occasions may be further associated with multiple CGs (e.g., including at least the CG). Additionally, or alternatively, the multiple first resource occasions may be associated with multiple cells (e.g. including at least the network entity 105-b).

In some examples, a first subset of the at least portion of the multiple first resource occasions may be associated with a first frequency and a second subset of the at least portion of the multiple first resource occasions may be associated with a second frequency.

In some examples, at 410, the UE 115-b may receive a second control message, which may be referred to as a skipping configuration indication. In some cases, the skipping configuration indication may signal a set of durations associated with the multiple first resource occasions. In such cases, each duration from the set of durations may be associated with an index.

Additionally, or alternatively, the skipping configuration indication may signal one or more logical channels over which the UE 115-b may refrain from skipping uplink transmitting. The one or more logical channels may be associated with an SRB or a delay sensitive QoS flow.

Additionally, or alternatively, the skipping configuration indication may signal whether the UE 115-b may transmit UCI via one or more third resource occasions associated with the uplink control channel that at least partially overlap with the one or more first resource occasions of the at least portion of the multiple first resource occasions or may transmit the UCI via the one or more first resource occasions of the at least portion of the multiple first resource occasions.

At 415, the UE 115-b may receive a third control message, which may be referred to as a PUCCH resource indication, indicating one or more second resource occasions of an uplink control channel (e.g., PUCCH resource occasions) associated with transmitting a skipping indication for the CG. In some examples, the one or more second resource occasions may be from multiple resource occasions of the uplink control channel.

In some cases, at 420, the UE 115-b may transmit, via the one or more second resource occasions, the skipping indication for the CG, where the one or more second resources occur prior to the multiple first resources in a time domain. The skipping indication may signal that the UE 115-b is to skip (e.g., or has skipped) uplink transmitting via at least a portion of the multiple first resource occasions. In some cases, the UE 115-b may select the one or more second resource occasions from the multiple resource occasions of the uplink channel.

In some cases, the skipping indication may include an indication of the at least portion of the multiple first resource occasions for which the UE 115-b is to skip uplink transmitting. Additionally, or alternatively, the skipping indication may include an indication of one or more durations from the set of durations, where the one or more durations are associated with the at least portion of the multiple first resource occasions. For example, the indication of the one or more durations may include an indication of the indices associated with the one or more durations.

Additionally, or alternatively, the skipping indication may include an indication of a first resource occasion of the multiple first resource occasions, where the skipping indication signals that the UE 115-b is to skip uplink transmitting for the multiple first resource occasions based on indicating the first resource occasion of the multiple first resource occasions.

In some cases (e.g., the multiple first resource occasions are associated with multiple CGs), the skipping indication may be applicable to the at least portion of the multiple first resource occasions across the multiple CGs. Additionally, or alternatively, the skipping indication may be applicable to a first cell (e.g., the network entity 105-b) of the multiple cells based on transmitting the skipping indication to the first cell.

In some cases, at 425, the UE 115-b may receive a fourth control message, which may be referred to as a PUSCH grant, scheduling data associated with the one or more logical channels over which the UE 115-b may refrain from skipping uplink transmitting.

In some cases, at 430, the UE 115-b may skip uplink transmitting via the at least portion of the first resource occasions based on transmitting the skipping indication.

In some cases, as described previously, one or more third resource occasions associated with the uplink control channel may at least partially overlap with the one or more first resource occasions of the at least portion of the multiple first resource occasions. In such cases, the UE 115-b may transmit, at 435, UCI via the one or more third resource occasions. Alternatively, the UE 115-b may multiplex the UCI with a TB and transmit the multiplex UCI via the one or more first resource occasions (e.g., overlapping first resource occasions) of the at least portion of the multiple first resource occasions.

In some cases, at 440, the UE 115-b may transmit the data associated with the one or more logical channels via the at least portion of the multiple first resource occasions based on the data being scheduled over the one or more logical channels after transmission of the skipping indication (e.g., instead of skipping the at least portion of the multiple first resource occasions).

In some cases, at 445, the UE 115-b may receive a fifth control message, which may be referred to as a retransmission request, requesting retransmission of data via the at least portion of the multiple first resource occasions. In some examples, the fifth control message may indicate a radio network temporary identifier (RNTI) associated with the UE 115-b and feedback process identifiers (e.g., HARQ process identifiers) associated with each first resource occasion of the at least portion of the multiple first resource occasions.

In some cases, at 450, the UE 115-b may transmit, via the one or more second resource occasions, the skipping indication for the CG, where the one or more second resources occur after the multiple first resources in the time domain. The skipping indication may signal that the UE 115-b is to has skipped uplink transmitting via at least a portion of the multiple first resource occasions (e.g., is to skip retransmission). In other words, the UE 115-b may transmit the skipping indication after the multiple first resources based on receiving the retransmission request).

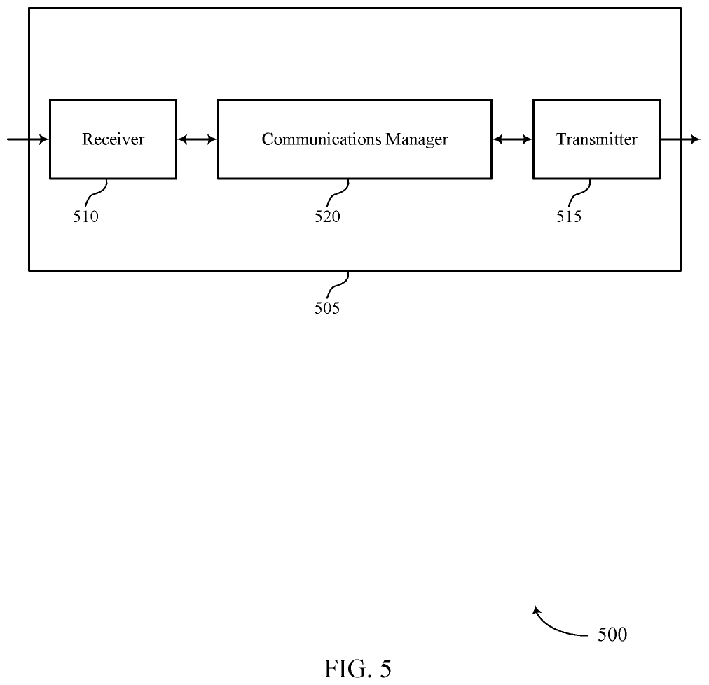

FIG. 5 illustrates a block diagram 500 of a device 505 that supports techniques for transmitting a skipping indication for CGs in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for transmitting a skipping indication for CGs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for transmitting a skipping indication for CGs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for transmitting a skipping indication for CGs as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving a first control message indicating a CG associated with a set of multiple first resource occasions of an uplink shared channel. The communications manager 520 may be configured as or otherwise support a means for receiving a second control message indicating one or more second resource occasions of an uplink channel (e.g., an uplink control channel) associated with transmitting a skipping indication for the CG, and may be configured as or otherwise support a means for selecting one or more resources of an uplink channel via which the UE is to transmit a skipping indication associated with the CG. The communications manager 520 may be configured as or otherwise support a means for transmitting, via the one or more resources, the skipping indication for the CG, the skipping indication signaling that the UE is to skip uplink transmitting via at least a portion of the set of multiple first resource occasions.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for transmitting a skipping indication signaling skipping of uplink transmitting via one or more resource occasions which may result in reduced processing, reduced power consumption, and more efficient utilization of communication resources, among other advantages.

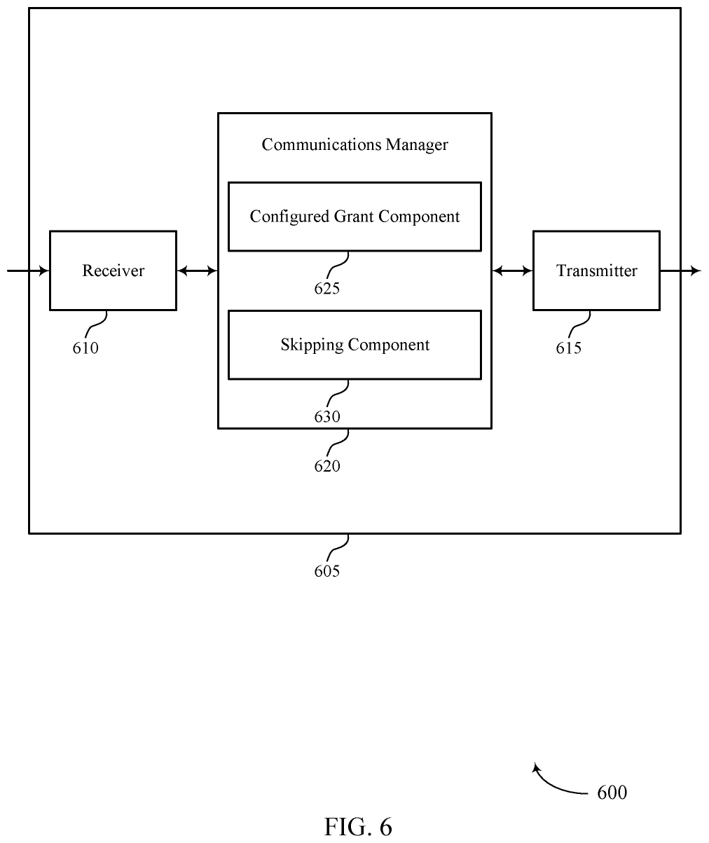

FIG. 6 illustrates a block diagram 600 of a device 605 that supports techniques for transmitting a skipping indication for CGs in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for transmitting a skipping indication for CGs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for transmitting a skipping indication for CGs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for transmitting a skipping indication for CGs as described herein. For example, the communications manager 620 may include a CG component 625 a skipping component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The CG component 625 may be configured as or otherwise support a means for receiving a first control message indicating a CG associated with a set of multiple first resource occasions of an uplink shared channel. The skipping component 630 may be configured as or otherwise support a means for receiving a second control message indicating one or more second resource occasions of an uplink channel (e.g., an uplink control channel) associated with transmitting a skipping indication for the CG, and may be configured as or otherwise support a means for selecting one or more resources of an uplink channel via which the UE is to transmit a skipping indication associated with the CG. The skipping component 630 may be configured as or otherwise support a means for transmitting, via the one or more resources, the skipping indication for the CG, the skipping indication signaling that the UE is to skip uplink transmitting via at least a portion of the set of multiple first resource occasions.

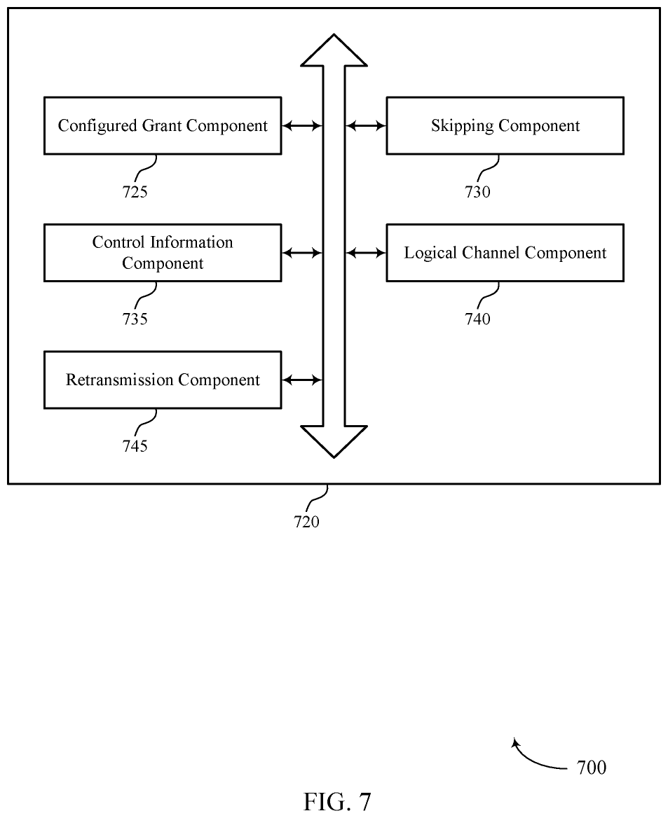

FIG. 7 illustrates a block diagram 700 of a communications manager 720 that supports techniques for transmitting a skipping indication for CGs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for transmitting a skipping indication for CGs as described herein. For example, the communications manager 720 may include a CG component 725, a skipping component 730, a control information component 735, a logical channel component 740, a retransmission component 745, or any combination thereof. Each of these components may communicate, directly or indirectly, with one another (e.g., via one or more buses).

The communications manager 720 may support wireless communications at a UE in accordance with examples as disclosed herein. The CG component 725 may be configured as or otherwise support a means for receiving a first control message indicating a CG associated with a set of multiple first resource occasions of an uplink shared channel. The skipping component 730 may be configured as or otherwise support a means for receiving a second control message indicating one or more second resource occasions of an uplink channel (e.g., an uplink control channel) associated with transmitting a skipping indication for the CG, and may be configured as or otherwise support a means for selecting one or more resources of an uplink channel via which the UE is to transmit a skipping indication associated with the CG. In some examples, the skipping component 730 may be configured as or otherwise support a means for transmitting, via the one or more resources, the skipping indication for the CG, the skipping indication signaling that the UE is to skip uplink transmitting via at least a portion of the set of multiple first resource occasions.

In some examples, the skipping indication occurs prior to the set of multiple first resource occasions in a time domain.

In some examples, to support transmitting the skipping indication for the CG, the skipping component 730 may be configured as or otherwise support a means for transmitting, via the skipping indication, an indication of the at least portion of the set of multiple first resource occasions for which the UE is to skip uplink transmitting.

In some examples, the skipping component 730 may be configured as or otherwise support a means for receiving a third control message indicating a set of durations associated with the set of multiple first resource occasions, where transmitting the skipping indication for the CG includes transmitting, via the skipping indication, an indication of one or more durations from the set of durations, and where the one or more durations are associated with the at least portion of the set of multiple first resource occasions.

In some examples, each duration from the set of durations is associated with an index. In some examples, the indication of the one or more durations includes an indication of the indices associated with the one or more durations.

In some examples, to support transmitting the skipping indication for the CG, the skipping component 730 may be configured as or otherwise support a means for transmitting, via the skipping indication, an indication of a first resource occasion of the set of multiple first resource occasions, where the skipping indication signals that the UE is to skip uplink transmitting for the set of multiple first resource occasions based on indicating the first resource occasion of the set of multiple first resource occasions.

In some examples, the set of multiple first resource occasions are further associated with a set of multiple CGs including at least the CG. In some examples, the skipping indication is applicable to the at least portion of the set of multiple first resource occasions across the set of multiple CGs.

In some examples, the set of multiple first resource occasions is associated with a set of multiple cells, and the skipping component 730 may be configured as or otherwise support a means for transmitting the skipping indication to the first cell of the set of multiple cells.

In some examples, the skipping component 730 may be configured as or otherwise support a means for skipping uplink transmitting via the at least portion of the set of multiple first resource occasions based on transmitting the skipping indication.

In some examples, the logical channel component 740 may be configured as or otherwise support a means for receiving a fourth control message indicating one or more logical channels over which the UE may refrain from skipping uplink transmitting.

In some examples, the logical channel component 740 may be configured as or otherwise support a means for receiving a third control message scheduling data associated with the one or more logical channels over which the UE may refrain from skipping uplink transmitting. In some examples, the logical channel component 740 may be configured as or otherwise support a means for transmitting the data associated with the one or more logical channels via the at least portion of the set of multiple first resource occasions based on the data being scheduled over the one or more logical channels after transmission of the skipping indication.

In some examples, each of the one or more logical channels is associated with an SRB or a delay sensitive QoS flow.

In some examples, the one or more resources occur after the set of multiple first resource occasions in a time domain.

In some examples, the retransmission component 745 may be configured as or otherwise support a means for receiving a third control message requesting retransmission of data via the at least portion of the set of multiple first resource occasions, where transmitting the skipping indication after the set of multiple first resource occasions is based on receiving the third control message.

In some examples, the third control message indicates an RNTI associated with the UE and feedback process identifiers associated each first resource occasion of the at least portion of the set of multiple first resource occasions.

In some examples, a second control message indicates a set of multiple resource occasions of the uplink channel, including at least the one or more resources.

In some examples, one or more third resource occasions associated with the uplink control channel at least partially overlap with one or more first resource occasions of the at least portion of the set of multiple first resource occasions, and the control information component 735 may be configured as or otherwise support a means for transmitting uplink control information via the one or more third resource occasions.

In some examples, one or more third resource occasions associated with the uplink control channel at least partially overlap with one or more first resource occasions of the at least portion of the set of multiple first resource occasions, and the control information component 735 may be configured as or otherwise support a means for multiplexing uplink control information with a transport block. In some examples, one or more third resource occasions associated with the uplink control channel at least partially overlap with one or more first resource occasions of the at least portion of the set of multiple first resource occasions, and the control information component 735 may be configured as or otherwise support a means for transmitting the multiplexed uplink control information via the one or more first resource occasions of the at least portion of the set of multiple first resource occasions.

In some examples, one or more third resource occasions associated with the uplink control channel at least partially overlap with one or more first resource occasions of the at least portion of the set of multiple first resource occasions, and the control information component 735 may be configured as or otherwise support a means for receiving a third control message indicating whether the UE may transmit uplink control information via the one or more third resource occasions or may transmit the uplink control information via the one or more first resource occasions.

In some examples, a first subset of the at least portion of the set of multiple first resource occasions is associated with a first frequency and a second subset of the at least portion of the set of multiple first resource occasions is associated with a second frequency.

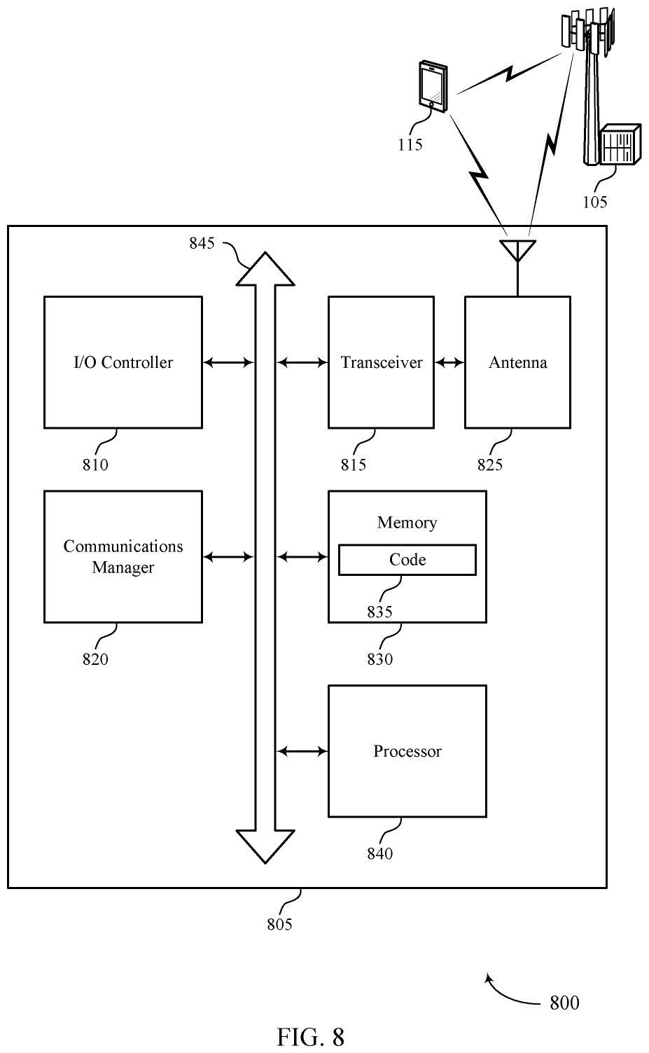

FIG. 8 illustrates a diagram of a system 800 including a device 805 that supports techniques for transmitting a skipping indication for CGs in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for transmitting a skipping indication for CGs). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a first control message indicating a CG associated with a set of multiple first resource occasions of an uplink shared channel. The communications manager 820 may be configured as or otherwise support a means for receiving a second control message indicating one or more second resource occasions of an uplink channel (e.g., an uplink control channel) associated with transmitting a skipping indication for the CG, and may be configured as or otherwise support a means for selecting one or more resources of an uplink channel via which the UE is to transmit a skipping indication associated with the CG. The communications manager 820 may be configured as or otherwise support a means for transmitting, via the one or more resources, the skipping indication for the CG, the skipping indication signaling that the UE is to skip uplink transmitting via at least a portion of the set of multiple first resource occasions.

By including or configuring the communications manager 820 in accordance with examples as described herein, the device 805 may support techniques for transmitting a skipping indication signaling skipping of uplink transmitting via one or more resource occasions which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for transmitting a skipping indication for CGs as described herein, or the processor 840 and the memory 830 may be otherwise configured to perform or support such operations.

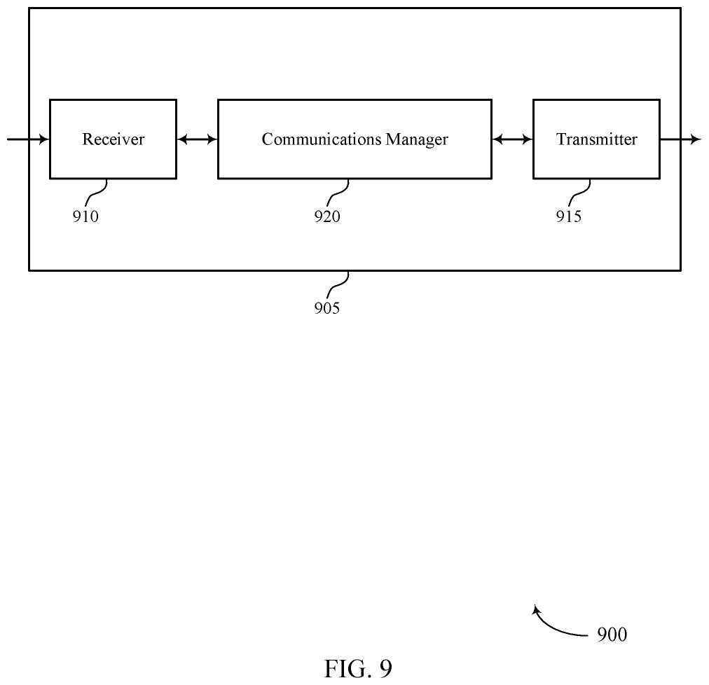

FIG. 9 illustrates a block diagram 900 of a device 905 that supports techniques for transmitting a skipping indication for CGs in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for transmitting a skipping indication for CGs as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting a first control message indicating a CG associated with a set of multiple first resource occasions of an uplink shared channel. The communications manager 920 may be configured as or otherwise support a means for transmitting a second control message indicating one or more second resource occasions of an uplink control channel associated with transmitting a skipping indication for the CG. The communications manager 920 may be configured as or otherwise support a means for receiving, via the one or more second resource occasions or via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for transmitting a skipping indication signaling skipping of uplink transmitting via one or more resource occasions which may result in reduced processing, reduced power consumption, and more efficient utilization of communication resources, among other advantages.

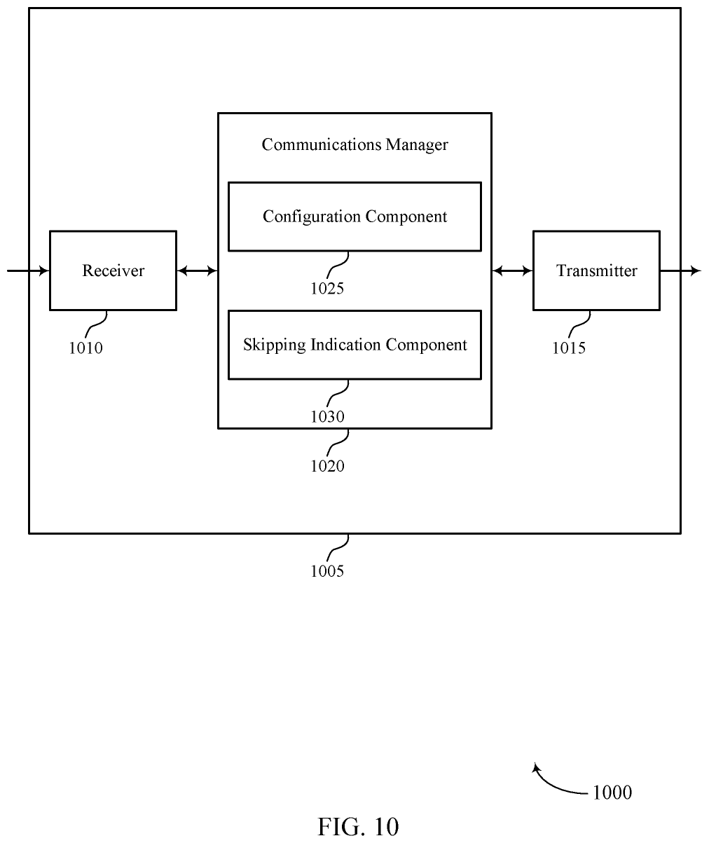

FIG. 10 illustrates a block diagram 1000 of a device 1005 that supports techniques for transmitting a skipping indication for CGs in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for transmitting a skipping indication for CGs as described herein. For example, the communications manager 1020 may include a configuration component 1025 a skipping indication component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The configuration component 1025 may be configured as or otherwise support a means for transmitting a first control message indicating a CG associated with a set of multiple first resource occasions of an uplink shared channel. The skipping indication component 1030 may be configured as or otherwise support a means for transmitting a second control message indicating one or more second resource occasions of an uplink control channel associated with transmitting a skipping indication for the CG. The skipping indication component 1030 may be configured as or otherwise support a means for receiving, via the one or more second resource occasions or via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions.

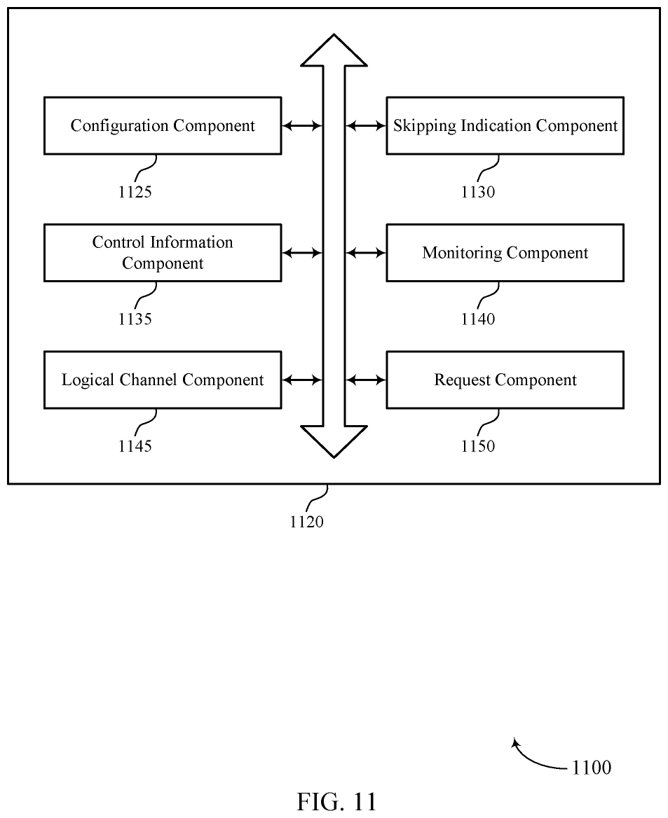

FIG. 11 illustrates a block diagram 1100 of a communications manager 1120 that supports techniques for transmitting a skipping indication for CGs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for transmitting a skipping indication for CGs as described herein. For example, the communications manager 1120 may include a configuration component 1125, a skipping indication component 1130, a control information component 1135, a monitoring component 1140, a logical channel component 1145, a request component 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The configuration component 1125 may be configured as or otherwise support a means for transmitting a first control message indicating a CG associated with a set of multiple first resource occasions of an uplink shared channel. The skipping indication component 1130 may be configured as or otherwise support a means for transmitting a second control message indicating one or more second resource occasions of an uplink control channel associated with transmitting a skipping indication for the CG. In some examples, the skipping indication component 1130 may be configured as or otherwise support a means for receiving, via the one or more second resource occasions or via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions.

In some examples, the skipping indication occurs prior to the set of multiple first resource occasions in a time domain.

In some examples, to support transmitting the skipping indication for the CG, the skipping indication component 1130 may be configured as or otherwise support a means for receiving, via the skipping indication, an indication of the at least portion of the set of multiple first resource occasions for which the UE is to skip uplink transmitting.

In some examples, the skipping indication component 1130 may be configured as or otherwise support a means for transmitting a third control message indicating a set of durations associated with the set of multiple first resource occasions, where transmitting the skipping indication for the CG includes transmitting, via the skipping indication, an indication of one or more durations from the set of durations, and where the one or more durations are associated with the at least portion of the set of multiple first resource occasions.

In some examples, each duration from the set of durations is associated with an index. In some examples, the indication of the one or more durations includes an indication of the indices associated with the one or more durations.

In some examples, to support transmitting the skipping indication for the CG, the skipping indication component 1130 may be configured as or otherwise support a means for receiving, via the skipping indication, an indication of a first resource occasion of the set of multiple first resource occasions, where the skipping indication signals that the UE is to skip uplink transmitting for the set of multiple first resource occasions based on indicating the first resource occasion of the set of multiple first resource occasions.

In some examples, the set of multiple first resource occasions is associated with a set of multiple cells. In some examples, the skipping indication is applicable to the at least portion of the set of multiple first resource occasions across the set of multiple cells.

In some examples, the skipping indication component 1130 may be configured as or otherwise support a means for transmitting a third control message indicating a first cell of the set of multiple cells for transmission of the skipping indication, where the skipping indication is transmitted to the first cell in accordance with the third control message.

In some examples, the set of multiple first resource occasions is associated with a set of multiple cells. In some examples, the skipping indication is applicable to a first cell of the set of multiple cells. In some examples, the network entity is the first cell.

In some examples, the monitoring component 1140 may be configured as or otherwise support a means for refraining from monitoring for uplink transmissions via the at least portion of the set of multiple first resource occasions based on receiving the skipping indication.

In some examples, the logical channel component 1145 may be configured as or otherwise support a means for transmitting a fourth control message indicating one or more logical channels over which the UE may refrain from skipping uplink transmitting.

In some examples, the logical channel component 1145 may be configured as or otherwise support a means for transmitting a third control message scheduling data over the one or more logical channels associated with the uplink control channel. In some examples, the logical channel component 1145 may be configured as or otherwise support a means for receiving the data over the one or more logical channels via the at least portion of the set of multiple first resource occasions based on the data being scheduled over the one or more logical channels after transmission of the skipping indication.

In some examples, each of the one or more logical channels is associated with an SRB or a delay sensitive QoS flow.

In some examples, the one or more resources occur after the set of multiple first resource occasions in a time domain.

In some examples, the request component 1150 may be configured as or otherwise support a means for transmitting a third control message requesting retransmission of data via the at least portion of the set of multiple first resource occasions, where receiving the skipping indication after the set of multiple first resource occasions is based on receiving the third control message.

In some examples, the third control message indicates an RNTI associated with the UE and indicates feedback process identifiers associated each first resource occasion of the at least portion of the set of multiple first resource occasions.

In some examples, a second control message indicates a set of multiple resource occasions of the uplink channel, including at least the one or more resources.

In some examples, one or more third resource occasions associated with the uplink control channel at least partially overlap with one or more first resource occasions of the at least portion of the set of multiple first resource occasions, and the control information component 1135 may be configured as or otherwise support a means for receiving uplink control information via the one or more third resource occasions.

In some examples, one or more third resource occasions associated with the uplink control channel at least partially overlap with one or more first resource occasions of the at least portion of the set of multiple first resource occasions, and the control information component 1135 may be configured as or otherwise support a means for receiving uplink control information multiplexed with a transport block via the one or more first resource occasions of the at least portion of the set of multiple first resource occasions.

In some examples, one or more third resource occasions associated with the uplink control channel at least partially overlap with one or more first resource occasions of the at least portion of the set of multiple first resource occasions, and the control information component 1135 may be configured as or otherwise support a means for transmitting a third control message indicating whether the UE may transmit uplink control information via the one or more third resource occasions or may transmit the uplink control information via the one or more first resource occasions.

In some examples, a first subset of the at least portion of the set of multiple first resource occasions is associated with a first frequency and a second subset of the at least portion of the set of multiple first resource occasions are associated with a second frequency.

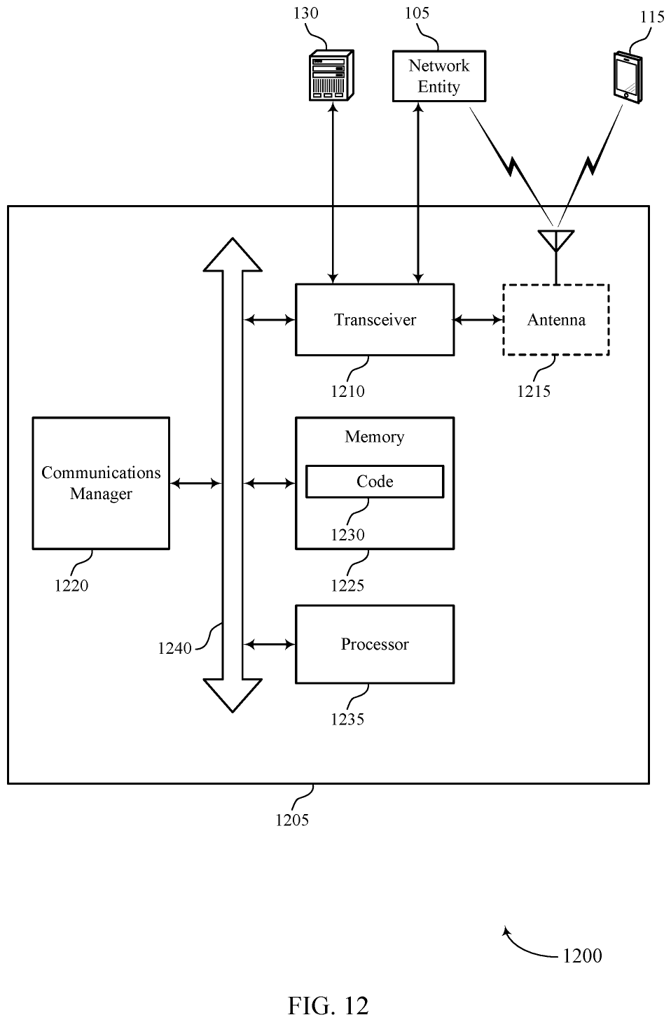

FIG. 12 illustrates a diagram of a system 1200 including a device 1205 that supports techniques for transmitting a skipping indication for CGs in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for transmitting a skipping indication for CGs). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting a first control message indicating a CG associated with a set of multiple first resource occasions of an uplink shared channel. The communications manager 1220 may be configured as or otherwise support a means for transmitting a second control message indicating one or more second resource occasions of an uplink control channel associated with transmitting a skipping indication for the CG. The communications manager 1220 may be configured as or otherwise support a means for receiving, via the one or more second resource occasions or via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions.

By including or configuring the communications manager 1220 in accordance with examples as described herein, the device 1205 may support techniques for transmitting a skipping indication signaling skipping of uplink transmitting via one or more resource occasions which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of techniques for transmitting a skipping indication for CGs as described herein, or the processor 1235 and the memory 1225 may be otherwise configured to perform or support such operations.

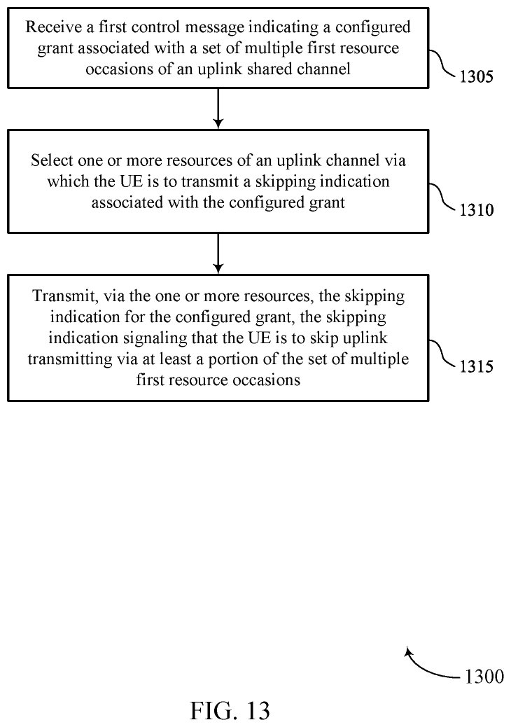

FIG. 13 illustrates a flowchart showing a method 1300 that supports techniques for transmitting a skipping indication for CGs in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first control message indicating a CG associated with a set of multiple first resource occasions of an uplink shared channel. The operations of 1305 may be performed in accordance with examples as disclosed herein. In some examples, aspects of the operations of 1305 may be performed by a CG component 725 as described with reference to FIG. 7.

At 1310, the method may include selecting one or more resources of an uplink channel via which the UE is to transmit a skipping indication associated with the CG. The operations of 1310 may be performed in accordance with examples as disclosed herein. In some examples, aspects of the operations of 1310 may be performed by a skipping component 730 as described with reference to FIG. 7.

At 1315, the method may include transmitting, via the one or more resources, the skipping indication for the CG, the skipping indication signaling that the UE is to skip uplink transmitting via at least a portion of the set of multiple first resource occasions. The operations of 1315 may be performed in accordance with examples as disclosed herein. In some examples, aspects of the operations of 1315 may be performed by a skipping component 730 as described with reference to FIG. 7.

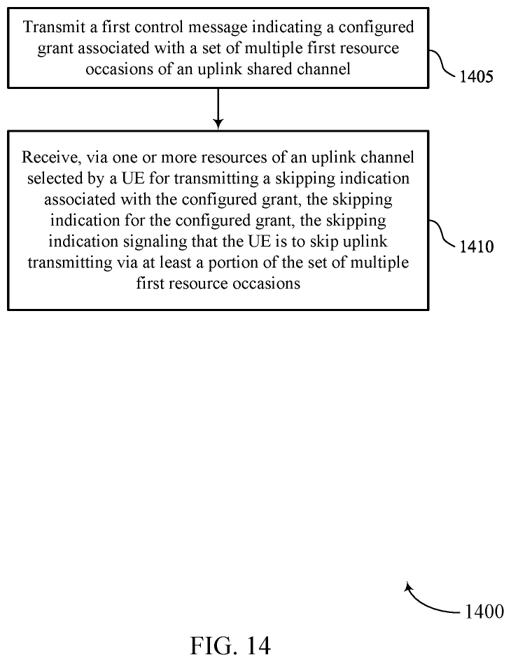

FIG. 14 illustrates a flowchart showing a method 1400 that supports techniques for transmitting a skipping indication for CGs in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a first control message indicating a CG associated with a set of multiple first resource occasions of an uplink shared channel. The operations of 1405 may be performed in accordance with examples as disclosed herein. In some examples, aspects of the operations of 1405 may be performed by a configuration component 1125 as described with reference to FIG. 11.

At 1410, the method may include receiving, via one or more resources of an uplink channel selected by a UE for transmitting a skipping indication associated with the CG, the skipping indication for the CG, the skipping indication signaling that the UE is to skip uplink transmitting via at least a portion of the set of multiple first resource occasions. The operations of 1415 may be performed in accordance with examples as disclosed herein. In some examples, aspects of the operations of 1415 may be performed by a skipping indication component 1130 as described with reference to FIG. 11.

The following provides an overview of aspects of the present disclosure:

Aspect 1: A method for wireless communications at a UE, comprising: receiving a first control message indicating a CG associated with a plurality of first resource occasions of an uplink shared channel; selecting one or more resources of an uplink channel via which the UE is to transmit a skipping indication associated with the CG; and transmitting, via the one or more resources, the skipping indication for the CG, the skipping indication signaling that the UE is to skip uplink transmitting via at least a portion of the plurality of first resource occasions.

Aspect 2: The method of aspect 1, wherein the skipping indication occurs prior to the plurality of first resource occasions in a time domain.

Aspect 3: The method of aspect 2, wherein transmitting the skipping indication for the CG comprises: transmitting, via the skipping indication, an indication of the at least portion of the plurality of first resource occasions for which the UE is to skip uplink transmitting.

Aspect 4: The method of aspect 3, further comprising: receiving a third control message indicating a set of durations associated with the plurality of first resource occasions, wherein transmitting the skipping indication for the CG comprises transmitting, via the skipping indication, an indication of one or more durations from the set of durations, and wherein the one or more durations are associated with the at least portion of the plurality of first resource occasions.

Aspect 5: The method of aspect 4, wherein each duration from the set of durations is associated with an index, and the indication of the one or more durations comprises an indication of the indices associated with the one or more durations.

Aspect 6: The method of any of aspects 2 through 5, wherein transmitting the skipping indication for the CG comprises: transmitting, via the skipping indication, an indication of a first resource occasion of the plurality of first resource occasions, wherein the skipping indication signals that the UE is to skip uplink transmitting for the plurality of first resource occasions based at least in part on indicating the first resource occasion of the plurality of first resource occasions.

Aspect 7: The method of any of aspects 2 through 6, wherein the plurality of first resource occasions are further associated with a plurality of CGs including at least the CG, and the skipping indication is applicable to the at least portion of the plurality of first resource occasions across the plurality of CGs.

Aspect 8: The method of any of aspects 2 through 7, wherein the plurality of first resource occasions is associated with a plurality of cells, and wherein the skipping indication is applicable to a first cell of the plurality of cells, the method further comprising: transmitting the skipping indication to the first cell of the plurality of cells.

Aspect 9: The method of any of aspects 2 through 8, further comprising: skipping uplink transmitting via the at least portion of the plurality of first resource occasions based at least in part on transmitting the skipping indication.

Aspect 10: The method of any of aspects 2 through 9, further comprising: receiving a fourth control message indicating one or more logical channels over which the UE may refrain from skipping uplink transmitting.

Aspect 11: The method of aspect 10, further comprising: receiving a third control message scheduling data associated with the one or more logical channels over which the UE may refrain from skipping uplink transmitting; and transmitting the data associated with the one or more logical channels via the at least portion of the plurality of first resource occasions based at least in part on the data being scheduled over the one or more logical channels after transmission of the skipping indication.

Aspect 12: The method of any of aspects 10 through 11, wherein each of the one or more logical channels is associated with a SRB or a delay sensitive QoS flow.

Aspect 13: The method of aspect 1, wherein the one or more resources occur after the plurality of first resource occasions in a time domain.

Aspect 14: The method of aspect 13, further comprising: receiving a third control message requesting retransmission of data via the at least portion of the plurality of first resource occasions, wherein transmitting the skipping indication after the plurality of first resource occasions is based at least in part on receiving the third control message.

Aspect 15: The method of aspect 14, wherein the third control message indicates a RNTI associated with the UE and feedback process identifiers associated each first resource occasion of the at least portion of the plurality of first resource occasions.

Aspect 16: The method of any of aspects 1 through 15, wherein a second control message indicates a plurality of resource occasions of the uplink channel, including at least the one or more resources.

Aspect 17: The method of any of aspects 1 through 16, wherein one or more third resource occasions associated with the uplink control channel at least partially overlap with one or more first resource occasions of the at least portion of the plurality of first resource occasions, the method further comprising: transmitting UCI via the one or more third resource occasions.

Aspect 18: The method of any of aspects 1 through 16, wherein one or more third resource occasions associated with the uplink control channel at least partially overlap with one or more first resource occasions of the at least portion of the plurality of first resource occasions, the method further comprising: multiplexing UCI with a TB; and transmitting the multiplexed UCI via the one or more first resource occasions of the at least portion of the plurality of first resource occasions.

Aspect 19: The method of any of aspects 1 through 18, wherein one or more third resource occasions associated with the uplink control channel at least partially overlap with one or more first resource occasions of the at least portion of the plurality of first resource occasions, the method further comprising: receiving a third control message indicating whether the UE may transmit UCI via the one or more third resource occasions or may transmit the UCI via the one or more first resource occasions.

Aspect 20: The method of any of aspects 1 through 19, wherein a first subset of the at least portion of the plurality of first resource occasions is associated with a first frequency and a second subset of the at least portion of the plurality of first resource occasions is associated with a second frequency.

Aspect 21: A method for wireless communications at a network entity, comprising: transmitting a first control message indicating a CG associated with a plurality of first resource occasions of an uplink shared channel; and receiving, via one or more resources of an uplink channel selected by a UE for transmitting a skipping indication associated with the CG, the skipping indication for the CG, the skipping indication signaling that the UE is to skip uplink transmitting via at least a portion of the plurality of first resource occasions.

Aspect 22: The method of aspect 21, wherein the skipping indication occurs prior to the plurality of first resource occasions in a time domain.

Aspect 23: The method of aspect 22, wherein transmitting the skipping indication for the CG comprises: receiving, via the skipping indication, an indication of the at least portion of the plurality of first resource occasions for which the UE is to skip uplink transmitting.

Aspect 24: The method of aspect 23, further comprising: transmitting a third control message indicating a set of durations associated with the plurality of first resource occasions, wherein transmitting the skipping indication for the CG comprises transmitting, via the skipping indication, an indication of one or more durations from the set of durations, and wherein the one or more durations are associated with the at least portion of the plurality of first resource occasions.

Aspect 25: The method of aspect 24, wherein each duration from the set of durations is associated with an index, and the indication of the one or more durations comprises an indication of the indices associated with the one or more durations.

Aspect 26: The method of any of aspects 22 through 25, wherein transmitting the skipping indication for the CG comprises: receiving, via the skipping indication, an indication of a first resource occasion of the plurality of first resource occasions, wherein the skipping indication signals that the UE is to skip uplink transmitting for the plurality of first resource occasions based at least in part on indicating the first resource occasion of the plurality of first resource occasions.

Aspect 27: The method of any of aspects 22 through 26, wherein the plurality of first resource occasions is associated with a plurality of cells, and the skipping indication is applicable to the at least portion of the plurality of first resource occasions across the plurality of cells.

Aspect 28: The method of aspect 27, further comprising: transmitting a third control message indicating a first cell of the plurality of cells for transmission of the skipping indication, wherein the skipping indication is transmitted to the first cell in accordance with the third control message.

Aspect 29: The method of any of aspects 22 through 28, wherein the plurality of first resource occasions is associated with a plurality of cells, and the skipping indication is applicable to a first cell of the plurality of cells, and the network entity is the first cell.

Aspect 30: The method of any of aspects 22 through 29, further comprising: refraining from monitoring for uplink transmissions via the at least portion of the plurality of first resource occasions based at least in part on receiving the skipping indication.

Aspect 31: The method of any of aspects 22 through 30, further comprising: transmitting a fourth control message indicating one or more logical channels over which the UE may refrain from skipping uplink transmitting.

Aspect 32: The method of aspect 31, further comprising: transmitting a third control message scheduling data over the one or more logical channels associated with the uplink control channel; and receiving the data over the one or more logical channels via the at least portion of the plurality of first resource occasions based at least in part on the data being scheduled over the one or more logical channels after transmission of the skipping indication.

Aspect 33: The method of any of aspects 31 through 32, wherein each of the one or more logical channels is associated with a SRB or a delay sensitive QoS flow.

Aspect 34: The method of aspect 21, wherein the one or more resources occur after the plurality of first resource occasions in a time domain.

Aspect 35: The method of aspect 34, further comprising: transmitting a third control message requesting retransmission of data via the at least portion of the plurality of first resource occasions, wherein receiving the skipping indication after the plurality of first resource occasions is based at least in part on receiving the third control message.

Aspect 36: The method of aspect 35, wherein the third control message indicates a RNTI associated with the UE and indicates feedback process identifiers associated each first resource occasion of the at least portion of the plurality of first resource occasions.

Aspect 37: The method of any of aspects 21 through 36, wherein a second control message indicates a plurality of resource occasions of the uplink channel, including at least the one or more resources.

Aspect 38: The method of any of aspects 21 through 37, wherein one or more third resource occasions associated with the uplink control channel at least partially overlap with one or more first resource occasions of the at least portion of the plurality of first resource occasions, the method further comprising: receiving UCI via the one or more third resource occasions.

Aspect 39: The method of any of aspects 21 through 37, wherein one or more third resource occasions associated with the uplink control channel at least partially overlap with one or more first resource occasions of the at least portion of the plurality of first resource occasions, the method further comprising: receiving UCI multiplexed with a TB via the one or more first resource occasions of the at least portion of the plurality of first resource occasions.

Aspect 40: The method of any of aspects 21 through 39, wherein one or more third resource occasions associated with the uplink control channel at least partially overlap with one or more first resource occasions of the at least portion of the plurality of first resource occasions, the method further comprising: transmitting a third control message indicating whether the UE may transmit UCI via the one or more third resource occasions or may transmit the UCI via the one or more first resource occasions.

Aspect 41: The method of any of aspects 21 through 40, wherein a first subset of the at least portion of the plurality of first resource occasions is associated with a first frequency and a second subset of the at least portion of the plurality of first resource occasions are associated with a second frequency.

Aspect 42: An apparatus for wireless communications at a UE, comprising a processor; memory coupled with the processor; and instructions stored in the memory and executable by the processor to cause the apparatus to perform a method of any of aspects 1 through 20.

Aspect 43: An apparatus for wireless communications at a UE, comprising at least one means for performing a method of any of aspects 1 through 20.

Aspect 44: A non-transitory computer-readable medium storing code for wireless communications at a UE, the code comprising instructions executable by a processor to perform a method of any of aspects 1 through 20.

Aspect 45: An apparatus for wireless communications at a network entity, comprising a processor; memory coupled with the processor; and instructions stored in the memory and executable by the processor to cause the apparatus to perform a method of any of aspects 21 through 41.

Aspect 46: An apparatus for wireless communications at a network entity, comprising at least one means for performing a method of any of aspects 21 through 41.

Aspect 47: A non-transitory computer-readable medium storing code for wireless communications at a network entity, the code comprising instructions executable by a processor to perform a method of any of aspects 21 through 41.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communications, comprising:
one or more processors; and
one or more memories coupled with the one or more processors and individually or collectively operable to cause the UE to:
receive a first control message indicating a configured grant associated with a plurality of first resource occasions of an uplink shared channel;
select one or more resources of an uplink channel via which the UE is to transmit a skipping indication associated with the configured grant; and
transmit, via the one or more resources, the skipping indication for the configured grant, the skipping indication signaling that the UE is to skip uplink transmitting via at least a portion of the plurality of first resource occasions.

2. The UE of claim 1, wherein the skipping indication occurs prior to the plurality of first resource occasions in a time domain.

3. The UE of claim 2, wherein, to transmit the skipping indication for the configured grant, the one or more processors are individually or collectively operable to cause the UE to:
transmit, via the skipping indication, an indication of the at least portion of the plurality of first resource occasions for which the UE is to skip uplink transmitting.

4. The UE of claim 3, wherein the one or more processors are individually or collectively further operable to cause the UE to:
receive a third control message indicating a set of durations associated with the plurality of first resource occasions, wherein transmitting the skipping indication for the configured grant comprises transmitting, via the skipping indication, an indication of one or more durations from the set of durations, and wherein the one or more durations are associated with the at least portion of the plurality of first resource occasions.

5. The UE of claim 4, wherein each duration from the set of durations is associated with an index, and wherein the indication of the one or more durations comprises an indication of the indices associated with the one or more durations.

6. The UE of claim 2, wherein, to transmit the skipping indication for the configured grant, the one or more processors are individually or collectively operable to cause the UE to:
transmit, via the skipping indication, an indication of a first resource occasion of the plurality of first resource occasions, wherein the skipping indication signals that the UE is to skip uplink transmitting for the plurality of first resource occasions based at least in part on indicating the first resource occasion of the plurality of first resource occasions.

7. The UE of claim 2, wherein the plurality of first resource occasions are further associated with a plurality of configured grants including at least the configured grant, and wherein the skipping indication is applicable to the at least portion of the plurality of first resource occasions across the plurality of configured grants.

8. The UE of claim 2, wherein the plurality of first resource occasions is associated with a plurality of cells, and the one or more processors are individually or collectively further operable to cause the UE to:
transmit the skipping indication to the first cell of the plurality of cells.

9. The UE of claim 2, wherein the one or more processors are individually or collectively further operable to cause the UE to:
skip uplink transmitting via the at least portion of the plurality of first resource occasions based at least in part on transmitting the skipping indication.

10. The UE of claim 2, wherein the one or more processors are individually or collectively further operable to cause the UE to:
receive a fourth control message indicating one or more logical channels over which the UE may refrain from skipping uplink transmitting.

11. The UE of claim 10, wherein the one or more processors are individually or collectively further operable to cause the UE to:
receive a third control message scheduling data associated with the one or more logical channels over which the UE may refrain from skipping uplink transmitting; and
transmit the data associated with the one or more logical channels via the at least portion of the plurality of first resource occasions based at least in part on the data being scheduled over the one or more logical channels after transmission of the skipping indication.

12. The UE of claim 10, wherein each of the one or more logical channels is associated with a signal radio bearer or a delay sensitive quality of service flow.

13. The UE of claim 1, wherein the one or more resources occur after the plurality of first resource occasions in a time domain.

14. The UE of claim 13, wherein the one or more processors are individually or collectively further operable to cause the UE to:
receive a third control message requesting retransmission of data via the at least portion of the plurality of first resource occasions, wherein transmitting the skipping indication after the plurality of first resource occasions is based at least in part on receiving the third control message.

15. The UE of claim 14, wherein the third control message indicates a radio network temporary identifier associated with the UE and feedback process identifiers associated each first resource occasion of the at least portion of the plurality of first resource occasions.

16. The UE of claim 1, wherein the one or more processors are individually or collectively further operable to cause the UE to:
receive a second control message indicating a plurality of resource occasions of the uplink channel, including at least the one or more resources.

17. The UE of claim 1, wherein one or more third resource occasions associated with the uplink control channel at least partially overlap with one or more first resource occasions of the at least portion of the plurality of first resource occasions, and the one or more processors are individually or collectively further operable to cause the UE to:
transmit uplink control information via the one or more third resource occasions.

18. The UE of claim 1, wherein one or more third resource occasions associated with the uplink control channel at least partially overlap with one or more first resource occasions of the at least portion of the plurality of first resource occasions, and the one or more processors are individually or collectively further operable to cause the UE to:
multiplex uplink control information with a transport block; and
transmit the multiplexed uplink control information via the one or more first resource occasions of the at least portion of the plurality of first resource occasions.

19. The UE of claim 1, wherein one or more third resource occasions associated with the uplink control channel at least partially overlap with one or more first resource occasions of the at least portion of the plurality of first resource occasions, and the one or more processors are individually or collectively further operable to cause the UE to:
receive a third control message indicating whether the UE may transmit uplink control information via the one or more third resource occasions or may transmit the uplink control information via the one or more first resource occasions.

20. The UE of claim 1, wherein a first subset of the at least portion of the plurality of first resource occasions is associated with a first frequency and a second subset of the at least portion of the plurality of first resource occasions is associated with a second frequency.

21. A network entity for wireless communications, comprising:
one or more processors; and
one or more memories coupled with the one or more processors and individually or collectively operable to cause the network entity to:
transmit a first control message indicating a configured grant associated with a plurality of first resource occasions of an uplink shared channel; and
receive, via one or more resources of an uplink channel selected by a user equipment (UE) for transmitting a skipping indication associated with the configured grant, the skipping indication signaling that the UE is to skip uplink transmitting via at least a portion of the plurality of first resource occasions.

22. The network entity of claim 21, wherein the skipping indication occurs prior to the plurality of first resource occasions in a time domain.

23. The network entity of claim 22, wherein, to transmit the skipping indication for the configured grant, the one or more processors are individually or collectively operable to cause the network entity to:
receive, via the skipping indication, an indication of the at least portion of the plurality of first resource occasions for which the UE is to skip uplink transmitting.

24. The network entity of claim 23, wherein the one or more processors are individually or collectively further operable to cause the network entity to:
transmit a third control message indicating a set of durations associated with the plurality of first resource occasions, wherein transmitting the skipping indication for the configured grant comprises transmitting, via the skipping indication, an indication of one or more durations from the set of durations, and wherein the one or more durations are associated with the at least portion of the plurality of first resource occasions.

25. The network entity of claim 24, wherein each duration from the set of durations is associated with an index, and wherein the indication of the one or more durations comprises an indication of the indices associated with the one or more durations.

26. The network entity of claim 22, wherein, to transmit the skipping indication for the configured grant, the one or more processors are individually or collectively operable to cause the network entity to:
receive, via the skipping indication, an indication of a first resource occasion of the plurality of first resource occasions, wherein the skipping indication signals that the UE is to skip uplink transmitting for the plurality of first resource occasions based at least in part on indicating the first resource occasion of the plurality of first resource occasions.

27. The network entity of claim 22, wherein the plurality of first resource occasions is associated with a plurality of cells, and wherein the skipping indication is applicable to the at least portion of the plurality of first resource occasions across the plurality of cells.

28. The network entity of claim 27, wherein the one or more processors are individually or collectively further operable to cause the network entity to:
transmit a third control message indicating a first cell of the plurality of cells for transmission of the skipping indication, wherein the skipping indication is transmitted to the first cell in accordance with the third control message.

29. A method for wireless communications at a user equipment (UE), comprising:
receiving a first control message indicating a configured grant associated with a plurality of first resource occasions of an uplink shared channel;
selecting one or more resources of an uplink channel via which the UE is to transmit a skipping indication associated with the configured grant; and
transmitting, via the one or more resources, the skipping indication for the configured grant, the skipping indication signaling that the UE is to skip uplink transmitting via at least a portion of the plurality of first resource occasions.

30. A method for wireless communications at a network entity, comprising:
transmitting a first control message indicating a configured grant associated with a plurality of first resource occasions of an uplink shared channel; and
receiving, via one or more resources of an uplink channel selected by a user equipment (UE) for transmitting a skipping indication associated with the configured grant, the skipping indication for the configured grant, the skipping indication signaling that the UE is to skip uplink transmitting via at least a portion of the plurality of first resource occasions.
